(19) United States
(12) Patent Application Publication
(10) Pub. No.: US 2011/0289085 A1
(43) Pub. Date: Nov. 24, 2011

(54) RECORDING METHOD

(75) Inventors: Junji Shiokawa, Chigasaki (JP); Hiroo Okamoto, Yokohama (JP); Mitsunobu Watanabe, Yokohama (JP)

(73) Assignee: Hitachi Consumer Electronics Co., Ltd.

(21) Appl. No.: 13/089,937

(22) Filed: Apr. 19, 2011

(30) Foreign Application Priority Data
May 21, 2010 (JP) 2010-116898

(51) Int. Cl. G06F 17/30

(52) U.S. Cl. 707/737; 707/E17.031

(57) ABSTRACT

In a recording method, in particular, for recording still pictures, while classifying the still pictures and managing the still pictures classified, wherein still picture data and management information for managing that still picture data are recorded therein. The management information includes information for classifying the still picture data into a classifying unit, each, and also includes a file format of the still picture data classified into the classifying unit mentioned above.

This application relates to and claims priority from Japanese Patent Application No. 2010-116898 filed on May 21, 2010, the entire disclosure of which is incorporated herein by reference.

### BACKGROUND OF THE INVENTION

The present invention relates to a recording apparatus.

As the background technology of the present technical field is Japanese Patent Laying-Open No. 2002-142185 (Patent Document 1). In that publication, the following description is made:

“(Problem(s) to be Dissolved) This invention has an object to provide an electronic camera apparatus and a file management method, for enabling a user to attach an arbitrary file name and/or a directory name, while maintaining the compatibility with the existing file management structure, according to DCF standard, and thereby improving the convenience of a user in file management.

(Dissolving Means) In the electronic camera apparatus, for recoding video data onto a recording medium of equipment, being connected in a manner of enabling data transmission, in a file management structure compatible with DCF standard, recording is made on the recording medium, into the directory recorded on the recording medium, with using a virtual directory name of format, which is not defined in DCF standard, and also producing a virtual directory management file corresponding to the virtual directory name thereof and a name of the directory corresponding thereto, being compatible with DCF standard, and thereby building up the structure of video data recorded on the recording medium, so that it can be managed unitarily, by a file for use of the virtual directory management (see, abstract).”

### <Prior Art Documents>

### <Patent Documents>

[Patent Document 1] Japanese Patent Laying-Open No. 2002-142185 (2002).

### BRIEF SUMMARY OF THE INVENTION

In the Patent Document 1 mentioned above is shown an example of the structure for managing a still picture; however, there is recorded no information, being most convenient when the user peruses or reads the virtual directory, as the management data within that virtual directory.

Then, according to the present invention, an object thereof is to provide a recording method suitable for managing the still picture. For example, it is the object to provide the recoding method suitable for managing a large number of the still pictures divided into folders, as the method for managing the still picture(s).

For accomplishing the object mentioned above, there is provided the method to be applied, which is described in the claims and will be mentioned later.

According to the present invention, it is possible to provide a convenient recording method for managing moving pictures and still pictures, depending on each of ways of using thereof.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a view for showing management condition of an AV stream in a recording/reproducing apparatus, according to the present invention;

FIG. 2 is a view for showing management condition of an AV stream in a recording/reproducing apparatus, according to the conventional example;

FIG. 3 is a block diagram of the recording/reproducing apparatus, according to the present invention;

FIG. 4 shows an example of a display output of original integration information;

FIG. 5 shows an example of display output, as a list of user definition integration information;

FIG. 6 shows an example of first display output of the user definition integration information;

FIG. 7 shows an example of second display output of the user definition integration information;

FIG. 8 is a view for showing an example of the file structures of each original integration information, play list integration information, user definition integration information, and play list information, program information, AV stream (program), etc.;

FIG. 9 shows an example of the structure of a management table of an each original integration information;

FIG. 10 shows an example of the structure of the play list management information and the management table;

FIG. 11 shows an example of the structure of original program management information and the management table;

FIG. 12 shows an example of the structure of user definition program information and the management table;

FIG. 13 shows an example of the structure of user definition integration management information and the management table;

FIG. 14 shows the structure of a packet of an AV stream file;

FIG. 15 shows processing of the packet of an AV stream file when time-sharing;

FIG. 16 shows an example of thumbnail management information;

FIG. 17 shows the structure of management information integration the thumbnail and the management table;

FIG. 18 shows the content of a named stream ProgramInfo 824 shown in FIG. 8;

FIG. 19 shows the details of ACU information 1900;

FIG. 20 shows the structure of program attached information to be recorded;

FIG. 21 shows the recording structure of a still picture;

FIG. 22 shows the file structure for distributing the recorded still picture to each folder;

FIG. 23 shows an example of folder management integration information for distributing the recorded still picture to each folder;

FIG. 24 shows an example of the details of the folder management integration information for distributing the recorded still picture to each folder;

FIG. 25 shows an example of the details of the management information of each folder, to which the recorded still picture is distributed for each;

FIG. 26 shows a system block diagram of a camera for executing still picture recording/reproducing;

FIG. 27 shows a flowchart of the process of a still picture recording/reproducing apparatus;

FIGS. 28A and 28B show an example of display outputs of the still picture management information divide for each folder and the still picture; and

FIG. 29 shows a system block diagram of a reproducing apparatus executing the still picture reproduction.

### DETAILED DESCRIPTION OF THE PREFERRED EMBODIMENTS

Hereinafter, embodiments according to the present invention will be fully explained by referring to the attached drawings.

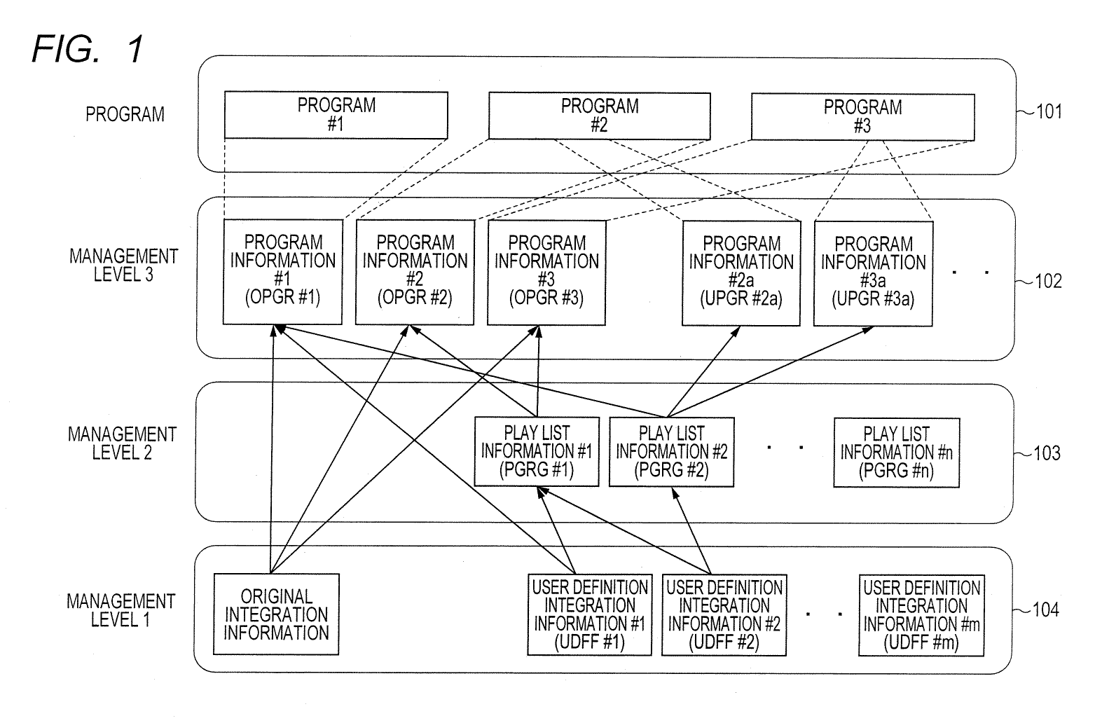

FIG. 1 is a view for showing a management condition of AV streams on a recoding medium, in a recording/reproducing apparatus according to the present embodiment. A reference numeral 101 depicts, similar to 201, an AV stream it self on the recording medium, and it shows, in particular, that in case where there are programs #1 to #3, as units of recording.

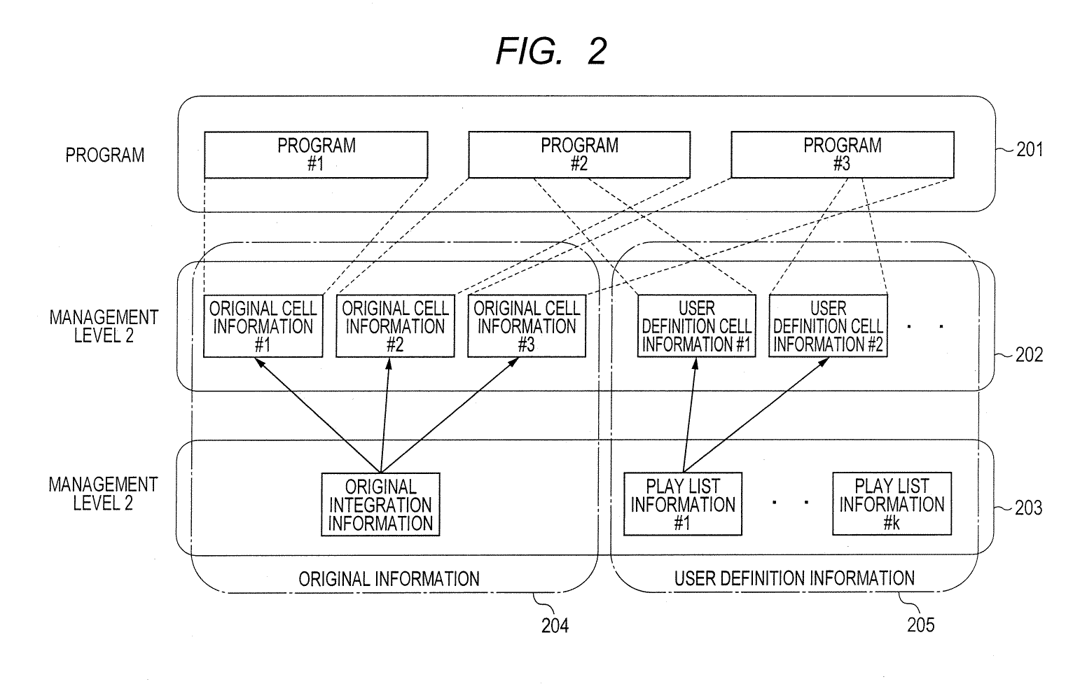

A reference numeral 102 corresponds to 202 in FIG. 2, and herein, it shows a third management layer or hierarchy (e.g., a management level 3) in management information. The program information #1 to #3 indicate all reproducing scopes or ranges of a program unit, such as, a program #1 to a program #3, respectively (hereinafter, those program information, each building up a pair with the substance of a program, are called “original program information”. Also, they are shown by, like “OPGR #1”, in FIG. 1). Also, program information #2a to program information #3a indicate all or a part of reproduction scope or range of programs, which a user designates, arbitrarily (hereinafter, being called, “user definition program”. Also, it is shown by, like “UPGR #2a”, in FIG. 1), and herein, a part of the program #2 and a part of the program #3 are shown, respectively. Portions corresponding to the program information #1 to #3 increases/decreases the information thereof, accompanying with addition or deletion of AV stream(s), i.e., an increase/decrease of programs. Also, portions corresponding to the program information #2a and the program information #3 increase/decrease the number of the information thereof, by editing operation by the user.

A reference numeral 103 corresponds to a management level 1 shown in FIG. 2; however, herein it indicates a second management layer or hierarchy (a management level 2), and includes only play list information #1 to play list information #n. Each of the play list information indicates a reproduction order or sequence of arbitrary program information on the management level 3 mentioned above, and may have plural numbers thereof.

A reference numeral 104 depicts, as a characterizing aspect of the present embodiment, a first management hierarchy (a management level 1) of management information, which is added, newly, and includes plural numbers of integration information. Original integration information is the integration information, memorizing system resume information, etc., therein, and details thereof will be mentioned later. User definition integration information #1 to #n include an arbitrary one or plural numbers of the play list information on the management level 2 and the program information on the management level 3. For example, in case where plural numbers of users use a single recording medium, it is possible to manage reproduction content, coincident with a taste or preference of each user, with using only one (1) of the user definition integration information, for each user.

Next, further detailed explanation will be given about the embodiment of the recording/reproducing apparatus, according to the present invention, by referring to other figure(s).

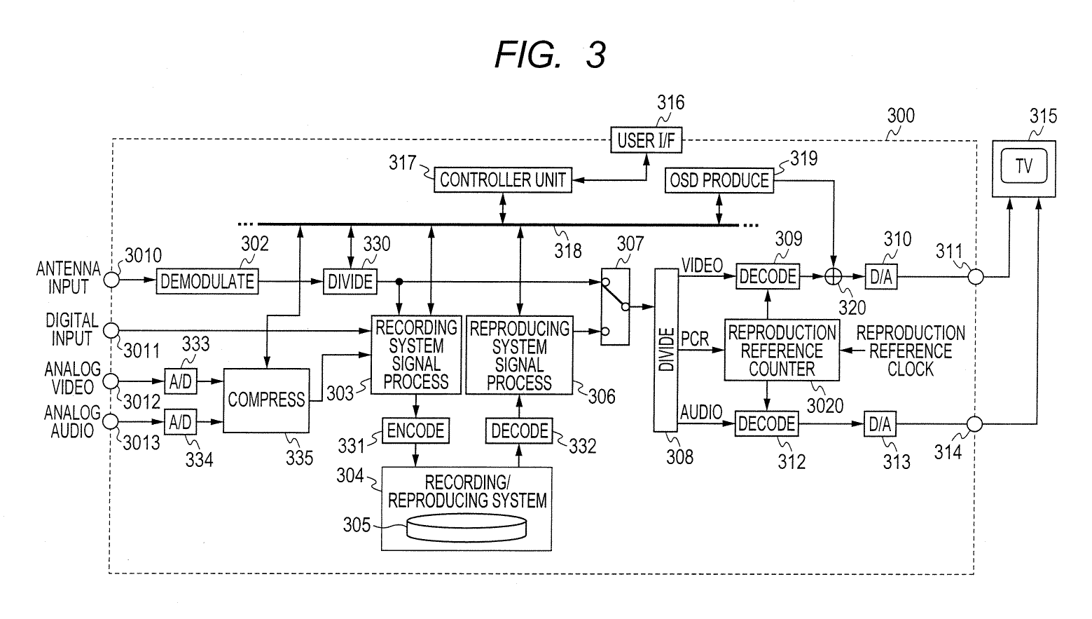

FIG. 3 is a block diagram for showing an example of the recording/reproducing apparatus, i.e., showing the recording/reproducing apparatus for enabling to receive a digital broadcast and record it to a recoding medium, and/or for reproducing data recorded, and for obtaining a reproduction output. A reference 300 depicts the recording/reproducing apparatus, 301 an input terminal for inputting a received wave from an antenna, 3011 an input terminal for inputting video/audio data from other equipment, which is compressed, 3012 an analog video input terminal for inputting an analog video signal, 3013 an analog audio input terminal for inputting an analog audio signal, 333 and 334 analog/digital (A/D) converter circuits for converting an analog signal to a digital signal, 302 a demodulator circuit, 330 a divider circuit for dividing digital signals into audio, video and other data, 335 a compressor circuit for compressing digitalized video and audio signals, 303 a recording system signal processor circuit, 331 an encoder circuit for encoding data to be recorded, 304 a recording/reproducing system including a drive function of a recording medium, 305 the recording medium, 332 a decoder circuit for decoding the data encoded and recorded on the recording medium, 306 a reproduction system signal processor circuit, 307 an exchanger circuit, 308 a divider circuit, 309 a video decoder circuit, 310 a digital/analog (D/A) converter circuit, 311 a video output terminal, 312 an audio decoder circuit, 3020 a reproduction reference counter, 313 a D/A converter circuit, 314 an audio output terminal, 315 a TV set, 316 a user I/F, 317 a controller unit, 318 a system bus, 319 an ISD producer unit and 320 an adder circuit, respectively.

When recording, a signal transmitted from a broadcast station through digital broadcasting, etc., and received by the present recording/reproducing apparatus, after being demodulated according to a predetermined method in the demodulator circuit 302, is treated by a necessary signal process, such as, addition of data for use of timing adjustment and/or demodulation, in the recording system signal processor circuit 303, and is encoded in the encoder circuit 331, and thereafter it is recorded on the recording medium 305 by the recording/reproducing system 304. Also, the digital signal inputted from the digital input terminal 3011 is treated with the necessary signal process, such as, addition of data for use of timing adjustment and/or demodulation, in the recording system signal processor circuit 303, and after being encoded in the encoder circuit 331, it is recorded on the recording medium 305 by the recording/reproducing system 304. Also, the analog video signal inputted from the analog video input terminal 3012 and the analog audio signal inputted from the analog audio input terminal 3013 are treated with compression process by the compressor circuit 335, and after encoded in the encoder circuit 331, through the recording system signal processor circuit 303, and are recorded on the recording medium 305 by the recording/reproducing system 304.

When reproducing, the digital data, which is read out from the recording medium 305 through the recording/reproducing system 304 responding to an instruction made by the user, is decoded within the decoder circuit 332, if encoded, or read out as it is through the decoder circuit 332, if not encoded, and within the reproducing system signal processor 306, it is treated with the signal processing necessary for reproduction, such as, a predetermined demodulation, etc., and transmitted to the divider circuit 308 through the exchanger circuit 307. When reproducing the AV stream of moving pictures, the divider circuit 308 distributes the AV stream to the video decoder circuit 309, audio decoder circuit 312 or the reproduction reference counter 3020, upon basis of PID (Packet Identifier, MPEG regulation or regulation) within the AV stream, which will be mentioned later. At the time when starting the reproduction, PCR (Program Clock Reference, MPEG regulation) value is set into the reproduction reference counter 3020, and thereafter, the reproduction reference counter 3020 is counted up by a reproduction reference clock to be used for demodulation. In the video decoder circuit 309, a predetermined video decoding process is treated, and after conversion is made from digital data into an analog signal in the D/A converter circuit 310, when the value of the reproduction reference counter 3020 is coincident with a value of display time, which is included in the AV stream of the video signal demodulated, it is displayed on a monitor output of the TV set through the video output terminal 311. Also, in the audio decoder circuit 312 is treated a predetermined audio decoding process, and when a value of the reproduction reference counter 3020 is coincident with the value of the display time, which is included in the AV stream of the audio signal demodulated, after the conversion is made from the digital data into the analog signal, it is outputted by an audio output mechanism of the TV set through the audio output terminal 314, and therefore the video and the audio are kept in synchronism with and are reproduced on the TV set. When reproducing a still picture, if it is encoded, it is decoded in the decoder circuit 332, or if not encoded, it is read out as it is, through the decoder circuit 332, and in the video decoder circuit 309 is treated an extension process thereon, in accordance with a predetermined compression method.

The controller unit 317 is for controlling each part of the recording/reproducing apparatus 300 through the system bus 318, and it controls the apparatus as a whole so as to execute operations upon basis of an instruction input inputted by the user through the user I/F 316. However, an instruction input request to the user, or an OSD display necessary is prepared in the OSD producer unit 319, and is added to an output of the video decoder circuit 309 at an appropriate level, in the adder circuit 320, and finally, it is outputted on a monitor screen of the TV set 315, to be achieved.

Next, as a detailed example of using the management information structure shown in FIG. 1, explanation will be given about the case where each of the integration information on a management level 1 is used for a menu display of the recoding data.

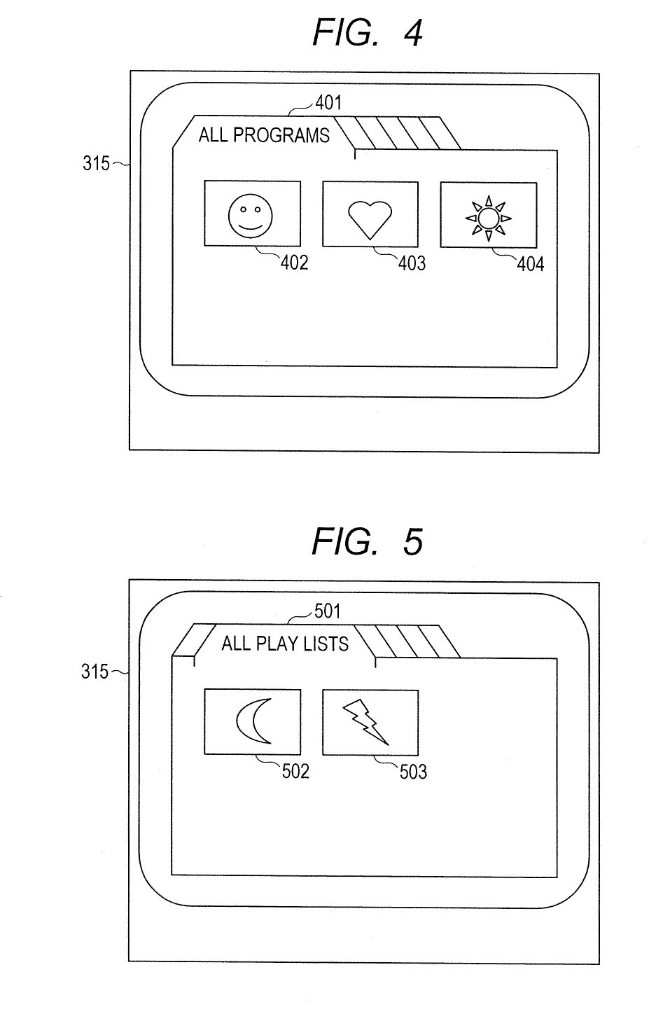

FIG. 4 shows an example of conducting a menu display with using the original integration information shown in FIG. 1. A reference numeral 315 depicts the TV set shown in FIG. 3, 401 a tag for use of displaying all programs, 402 a thumbnail indicating the program information #1, 403 a thumbnail indicating the program information #2, 404 a thumbnail indicating the program information #3, respectively. The user can reproduce an arbitrary one or all of the programs, by moving a cursor position on a screen by a remote controller, etc., to a desired thumbnail, and thereby selecting and determining it.

Next, FIG. 5 shows an example of conducting the menu display with using one of a several number of user definition integration information shown in FIG. 1, using this as a play list. A reference numeral 501 depicts a tag for use of displaying all play lists, 502 a thumbnail indicating the play list #1, 503 a thumbnail indicating the play list #2, respectively. Similar to the case mentioned above, the user can reproduce an arbitrary one or all of the play lists, by moving the cursor position on the screen by the remote controller, etc., to a desired thumbnail, and thereby selecting and determining it. However, exchange of the display from the above-mentioned tag 401 for use of displaying all program to the tag for use of displaying all play lists 501 can be achieved, for example, with moving the cursor by user to the position of characters of that tag, etc.

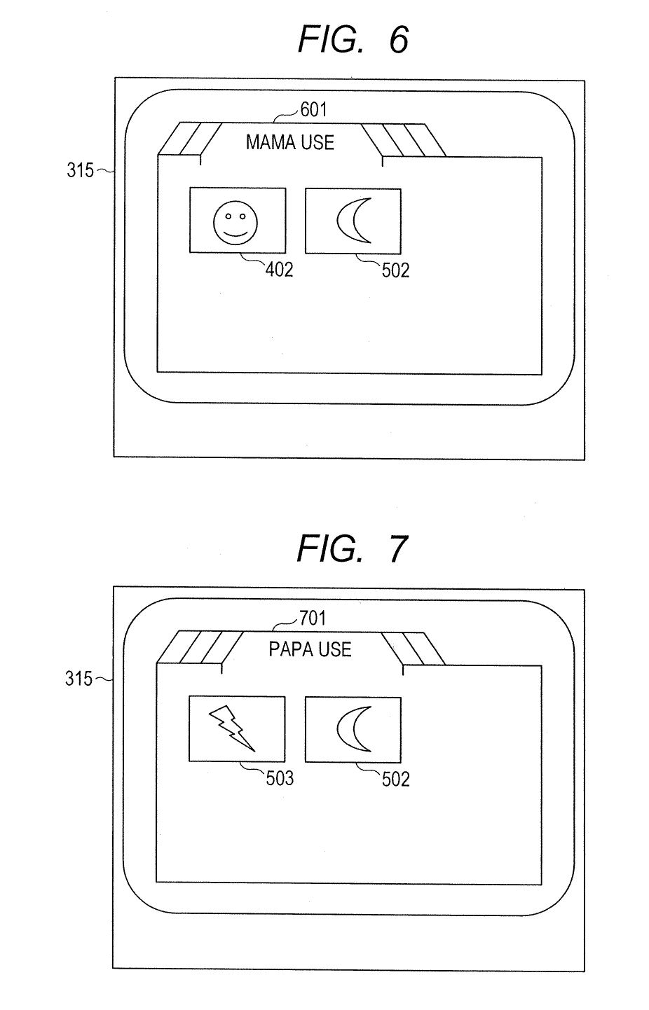

Next, FIG. 6 shows an example of conducting the menu display with using the user definition integration information #1 shown in FIG. 1. A reference numeral 601 depicts a tag for use of a menu display for the user #1 (herein, it is assumed “mama”), and 402 and 502, as can be seen from FIG. 1, depict the thumbnails of the program information #1 and the play list information #1, respectively. The “mama” is able to register or delete data to be reproduced, freely, with using the tag 601 for use of the menu display for the mama as a folder for exclusive use of herself.

Similarly, FIG. 7 shows an example of conducting the menu display with using the user definition integration information #2 shown in FIG. 1. A reference numeral 701 depicts a tag for use of a menu display for the user #2 (herein, it is assumed “papa”), and 502 and 503, as can be seen from FIG. 1, depict the thumbnails of the program information #2 and the play list information #2, respectively. Also, similar to the “mama” mentioned above, “papa” is able to register or delete data to be reproduced, freely, with using the tag 701 for use of the menu display for the papa as a folder for exclusive use of himself.

As was mentioned above, according to the embodiment of the present invention, a management unit and an upper management hierarchy for managing all of the play list information registered are added, thereby achieving the structure for dealing with on the same line to the integration information, which indicates the reproduction range for all of the AV streams. Also, structure is so made that the integration information defined by the user can be treated on the management hierarchy added; thereby an arbitrary reproduction range included in a low hierarchy can be registered into the integration information defined by the user. With this, the user can make management by selecting an arbitrary play list or the reproduction range.

In this manner, even in case where a single recording medium is shared by plural numbers of users, etc., it is possible to manage favorite reproduction content for each user, and thereby improving the usability.

However, in the embodiment mentioned above, although mentioning was made on the case of receiving the digital broadcast and recording it as it is; however, it should be limited to this, and may be constructed to provide a network I/F, thereby recoding analog data onto the recording medium while encoding it. Thus, in the present embodiment, mentioning was med about the data management on the recording medium, but should not be limited, in particular, about an input path thereof.

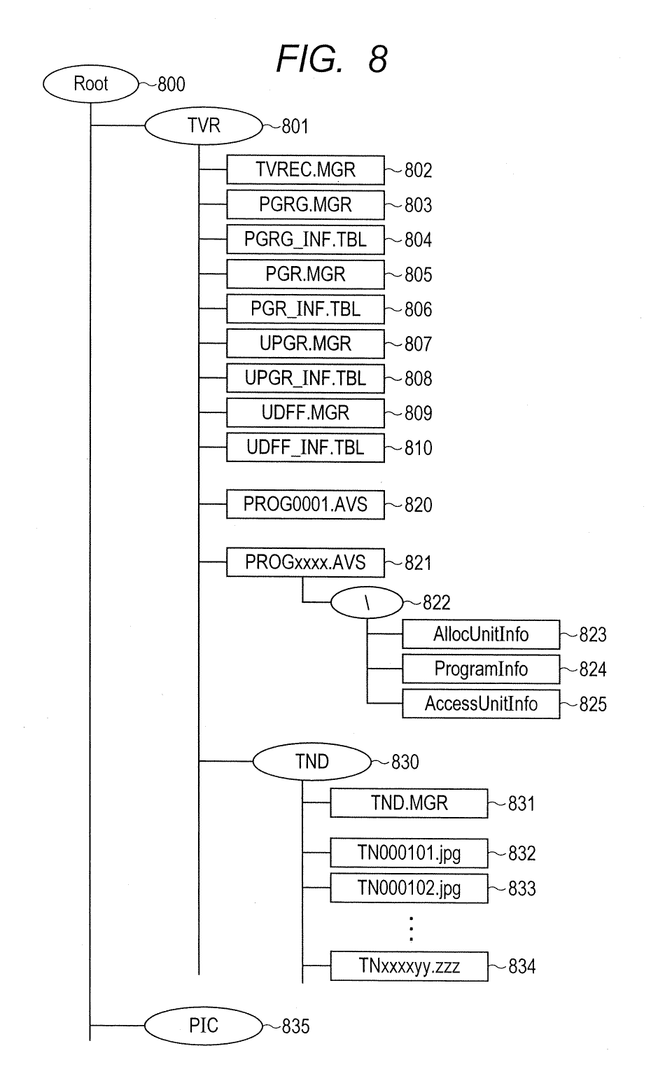

In FIG. 8 is shown an example of away, in which file structure the program and the program information, which are mentioned above, the play list information, and the original integration information are recorded on the recording medium 305 (FIG. 3), actually. The present recording medium is a medium to be executed digital recording/reproducing thereon, wherein each file on the medium is managed on a file system similar to that to be used for management of the recording medium, such as, in so-called a personal computer, etc. In the same figure, ROOT 800 indicates the uppermost hierarchy of a file directory, and TVR 801 a directory of a low hierarchy thereof, i.e., showing each file structure for achieving the management structure shown in FIG. 1 relating to the present invention. A management file, such as, TVREC.MGR 802, PGRG.MGR 803, PGRG_INF.TBL 804, PGR.MGR 805, PGR_INF.TBL 806, UPGR.MGR 807, UPGR_INF.TBL 808, UDFF.MGR 809, UDFF_INF.TBL 810, etc., and an AV stream PROG 0001.AVS 820, . . . PROGxxxx.AVS (part of xxxx of the AV stream file is attached with numbers, and a sequential number increases every time when the AV stream is recorded, for example) 821 are recorded under the TVR 801. 830 is a directory further below the TVR 801, and is a directory having a directory name of “TND” for storing files relating to the thumbnails to be used in a navigation list, which is recoded on the recording medium, etc. 831 is a thumbnail management file for integrally manage substance files 832, 833, . . . 834, such as, a file name “TND.MGR”. A file name of the substance file of the thumbnail is assumed “NTxxxxyy.zzz”, wherein “xxxx” corresponds to “xxxx” of the program file 821, “yy” is assigned with numerals of an order registered as the thumbnail, and part of “zzz” is “bmp” if the type of data of the thumbnail is a bitmap of non-compression, or “jpg” if it is JPEG (Joint Photographic Experts Group) compressed. In the present embodiment, files each having thumbnail corresponding to each program file are separately recorded, respectively, like 832-834. In this manner, by recording plural numbers of files of thumbnail, separately, like 832-834, without combining them into one (1) file, processing when adding/deleting the files of thumbnail comes to be easy. In particular, in a recording medium having large capacity, such as, a removable hard disc, etc., it is possible to obtain shortening of the processing time when deleting/adding the file(s) of thumbnail. Also, 835 depicts the directory of the name of “PIC”, for reserving the management file and/or the still picture data for executing the management of still picture. Details about the directory 835 will be mentioned, later.

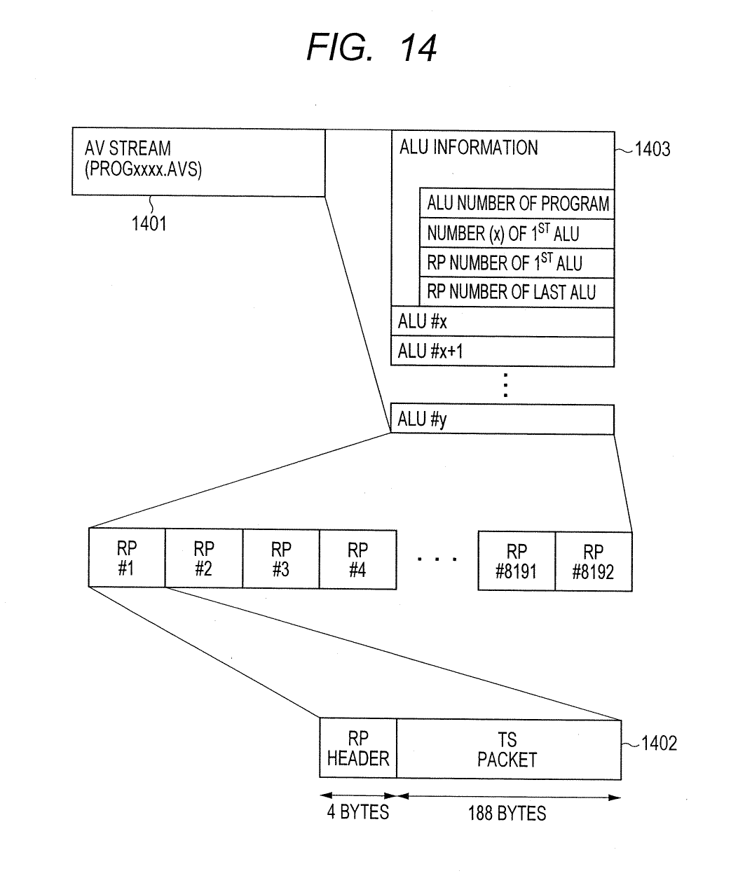

The AV stream files 820 (PROG0001.AVS) and 821 (PROGxxxx.AVS) shown in FIG. 8 are recorded with the structure shown in FIG. 14.

In FIG. 14, it is assumed that a reference numeral 1401 depicts the AV stream file, and that the minimum unit when recording the AV stream received on the air is “ALU”. Also, when the AV stream is encoded, “ALU” is the minimum unit of the encoding. PR 1402 is a data packet of 192 bytes, adding the timestamp when receiving (counted by 27 MHz, the count value is 4 bytes when receiving) to a transport packet (188 bytes) of MPEG (Moving Picture Expert Group) standard, as a header, by a unit of a recoding packet, and in the present embodiment, 8,192 pieces of this RP packet 1402 of 192 bytes are combined with, thereby building up 1 ALU. Within the AV stream file 1401 are recorded, in addition o the AV stream recording ALU#1-ALU#v (each 8,192 RP) therein, sequentially, as ALU information 1403, there are recorded a total ALU number of the AV streams recorded, a first ALU number, an RP number of the first ALU, and a RP number of the last ALU of the AV stream. The ALU information 1403 corresponds to “AllocUnitInfo” 823 shown in FIG. 8. This is, because there is a possibility that the RP number of the first ALU and the last ALU of the AV stream do not come to be 8,192, and therefore to record this fact therein (details thereof will be mentioned, later).

Also, each of those AV streams 820 and 821 has the structure of stream directory 822 in a lower layer or hierarchy of the file structure, which is defined by UDF (Universal Disc Format), for example, and further has files “AllocUnitInfo” 823, “ProgramInfo” 824 and “AccessUnitInfo” 825, which are called a named stream.

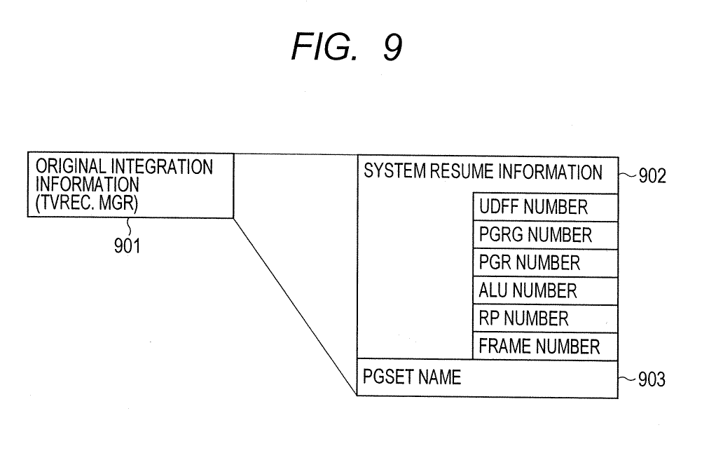

FIG. 9 shows the structure of a management table of “TVREC.MGR” 802 (FIG. 8). As the original integration information 901 are recorded system resume information 902 and program integration name 903.

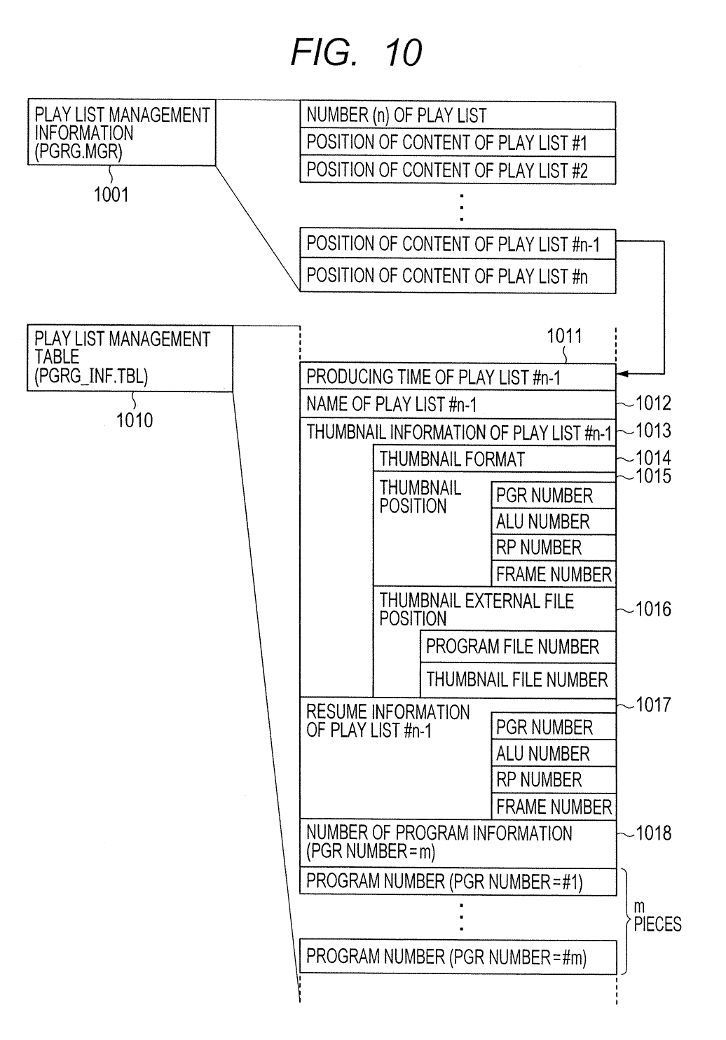

As the system resume information are recorded the following, in the form of a table: a number of user definition integration information (UDFF) at the time when the user stop reproduction and a play list information (PGRG) number of the hierarchy lower than that; a number (PGR) of original program information (OPGR) or user definition program information (UPGR) of the hierarchy lower than that; an ALU number, i.e., the minimum unit when recording the AV stream corresponding to GOP, at the time when stopping, which will be mentioned later; an RP number of the recoding packet of corresponding GOP in that ALU; and a frame number of the corresponding GOP. With doing in this manner, control when starting the resume reproduction of the system can be performed, at an accuracy of a frame unit. For determining on whether OPGR or UPGR, the PGR number is distinguished from, between that for OPGR of PGR number (hexadecimal)=0000 to 7FFF, and that for UPGR of PGR number (hexadecimal)=8000 to FFFF, for example. 903 depicts a field for recoding a name (PGSET name) therein, to be given to the program integration information, and for example, there is recorded character line of the name, which the user gives for a content group recorded on the recording medium. With doing this, it can be used for determining, by whom the recoding medium is used, etc., and also a name relating to the content group can be recorded therein, then there can be obtained an advantage that the recording content can be grasped easily. FIG. 10 shows contents of a play list management information (PGRG) file 1001 for managing the play list, and a play list management table file 1010. The play list management information (PGRG) file corresponds to “PGRG.MGR” 803 in FIG. 8, and the play list management table file 1010 to “PGRG_INF.TAB” 804 shown in FIG. 8, respectively. In PGRG.MGR 1001 are recorded the number of the play list(s), which is/are registered by the user through editing (FIG. 10 shows the case of “n” pieces), and the information of position of a play list management table file PGRG_INF.TBL, recording hereinafter the contents of a play list #1, a play list #2 . . . and a play list #n−1 therein (such as, the information of at which number of bytes it starts from a head of the play list management table file PGRG_INF.TBL 1010, for example).

In the play list management table file 1010 are recorded the information of the play lists #1, . . . , #n−1, #n, which will be mentioned below, in the form of a table. As a detailed example of the play list management table 1010 shown in FIG. 10, the structure of the play list #n−1 will be shown. As the information of the play list #n−1 are recorded the followings: producing or creating time 1011 (time at a time-point when the user produces or creates the play list #n−1 by operating the apparatus), and a name 1012; thumbnail information 1013, resume information 1017, and a number 1018 of the original program information (OPGR), which is registered in the play list #n−1 following thereafter, or the program information indicating the user definition program information (UPGR); and a number of registered number list program information (PGR information. Distinction between OPGR and UPGR is as was mentioned previously, thus, OPGR if the number of PGR (hexadecimal) is equal to or less than 7FFF, and UPGR if it is equal to or greater 8000).

Since the producing time 1011 of the play list is recorded as the management information, it is possible to display a play list, such as, in the order of the producing time thereof, for example, when reproducing.

Thumbnail information 1013 shown in FIG. 10 is make up with format information (i.e., necessity/un-necessity of content protection, thumbnail to be displayed must be produced upon basis of a reference position on a picture of the AV stream recorded, or refer to thumbnail data registered in an external file, etc.) 1014, position information 1015 for displaying as the thumbnail within the AV stream, and thumbnail data position information 1016 of the external file. The thumbnail position information 1015 is made up with a program information (PGR) number to be displayed as the thumbnail, a number of ALU corresponding to GOP position of the thumbnail, which the AV stream corresponding to that PGR number displays, a RP number among the ALU numbers corresponding to that GOP, and a frame number to be displayed as the thumbnail of that GOP.

The resume information 1017 records therein, a program (PGR) number, which is under reproduction at the time when the production of the play list #n−1 is stopped (OPGR if the PGR number is equal to or less than 7FFF, or UPGR if it is equal to or greater tha 8000), the ALU number corresponding to GOP at the time point when the reproduction is stopped at that RGR number, the RP number, and the frame number at the time when stopping within GOP mentioned above. With this structure, in addition to the system resume information 902 shown in FIG. 9, the resume is able to make recording management upon the resume information, separately or independently, like the resume information, for each separate original program information or the play list of the user definition. Accordingly, when reproducing, as a resume reproduction function, it is possible to provide a function for enabling a resume reproduction control, including, for example, to execute the reproduction control at a resume point for each original program, or to notice at which number of the user definition integration information (UDFF) the reproduction was stopped, depending on the previous reproduction stopping condition, and also to execute the control on start of reproduction at an accuracy of a unit of the frame.

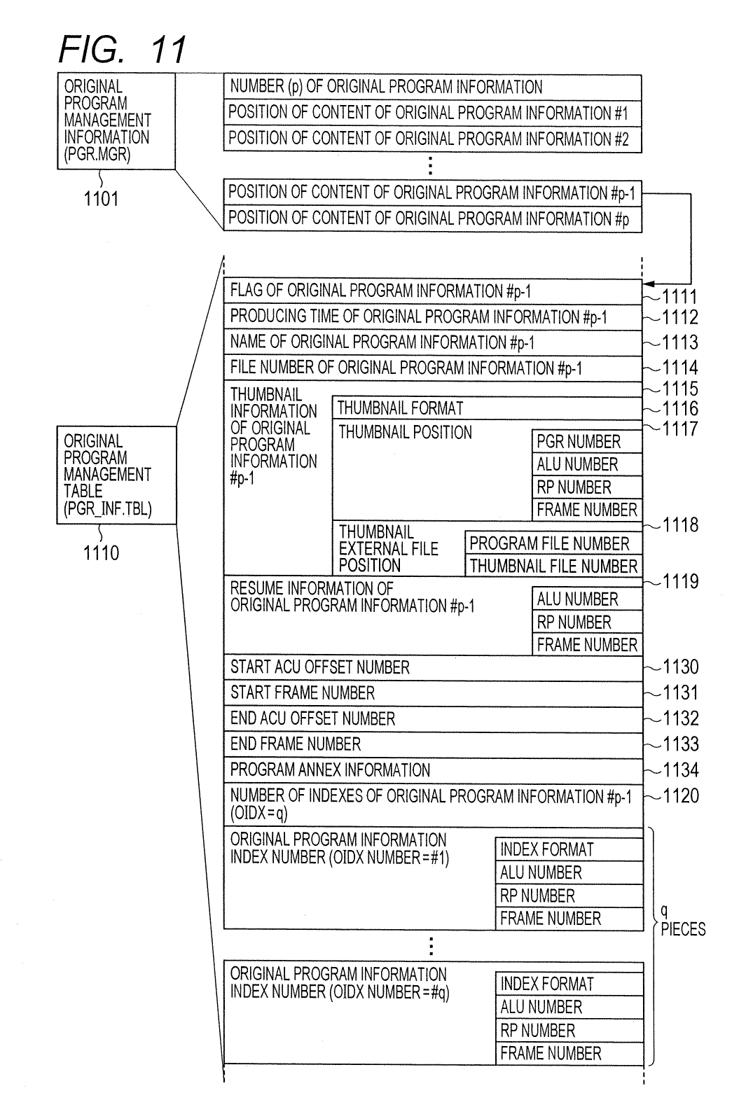

FIG. 11 shows contents of an original program management information (OPGR) file 1101 and an original program management table file 1110. The user can reproduce all of the AV streams, which are recorded on the recoding medium, after reproducing those, including all of the original program information on the recording medium, back to the original thereof. The original program management information (OPGR) file 1101 corresponds to PGR.MGR 805 shown in FIG. 8, and the original program management table file 1110 to PGR INF.TBL 806 shown in FIG. 8, respectively. The original program management information (OPGR) file 1101 records therein a number of the original programs (FIG. 11 shows the case of “p” pieces), hereinafter the information of position within the original program management table file 1110 recording the original program information #1, the original program information the original program information #n−1 and the original program information #n therein (such as, the information of at which number of bytes it starts from a head of the original program management table file PGR_INF.TBL 1110, for example).

As a detailed example of the original program management table 1110 shown in FIG. 11 is shown a table portion of a play list #p−1. As the information of the play list #p−1, there are disposed the followings: a program information flag 1111, indicating on whether this original program of #p−1f is valid or invalid, copy control information (hereinafter, being called “CCI”), etc.; producing time 1112 (time at a time-point when the user produces the original program information #p−1 by operating the apparatus), and a name 1113; a thumbnail file number (“xxxx” of PROGxxxx.AVS 821 shown in FIG. 8); thumbnail information 1115; resume information 1119; further, an index number 1120 and a form of each index number, and also the ALU number and the RP number corresponding to GOP of the AV stream corresponding to the program information #p−1, which indicates the position of the index; and a frame number, which is designated as an index within that GOP. The index is designated position information, which the user designates a marking designation point when editing the program corresponding to the original program information #p−1, for example, and if designating the index in the editing, it enables operations, such as, jumping the program corresponding to the original program information #p−1 to the position, which is designated by the index, quickly, when reproducing, etc., by a unit of the frame. A thumbnail format 1116, a thumbnail position 1117 and a thumbnail external file position 1118, each being the constituent component of the thumbnail information 1115, have the data structures similar to that of the thumbnail format 1014, the thumbnail position 1015 and the thumbnail external file position 1016 within the play list management table 1010 shown in FIG. 10 previously mentioned. And, the constituent elements of the resume information 1119 also are similar to those of the resume information 1017 shown in FIG. 10 previously mentioned.

Also, into a start ACU offset number 1130 is recorded a difference value from a first GOP position of the AV stream of the original program recorded to GOP corresponding to the first reproduction position, and into a start frame number 113 is recorded a frame number of that GOP, which is desired to be reproduced. About the definition of an ACU entry number, it will be mentioned later. Also, into an end ACU offset number 1132 is recorded a difference value from GOP at a terminal of the AV stream of the original program recorded to the ACU entry number corresponding to GOP at a terminal to be reproduced, and into an end frame number is recorded the frame number to be reproduced within GOP at the terminal to be reproduced. With doing so, among the streams recorded, it is possible to prevent unnecessary portions before and after thereof from being reproduced. Also, by defining a magnitude of the difference value from the top of the AV stream of the original program, which is recorded actually, up to a start of the reproduction, and further, by defining the difference value from the terminal of the AV stream of the original program, which is recorded actually, up to the terminal to be reproduced, it is possible to narrow a time gap between the AV stream of the original program, which is recoded actually, and the AV stream of the original program to be reproduces, within a predetermined amount or quantity. Therefore, for example, in case where the data of this reproduction range is destroyed due to any factor, there is a possibility of falling into a situation that it cannot be reproduced at all, in the worst case; however it is possible to lessen the range, on which reproduction cannot be made, by suppressing it within the predetermined amount or quantity. However, the start ACU offset number 1130 and the end ACU offset number 1132 may be absolute values (not, the difference value) of the ACU entry numbers designating the range to be reproduced.

Also, in program annex information 1134 shown in FIG. 11 is described annex information within the AV stream recorded.

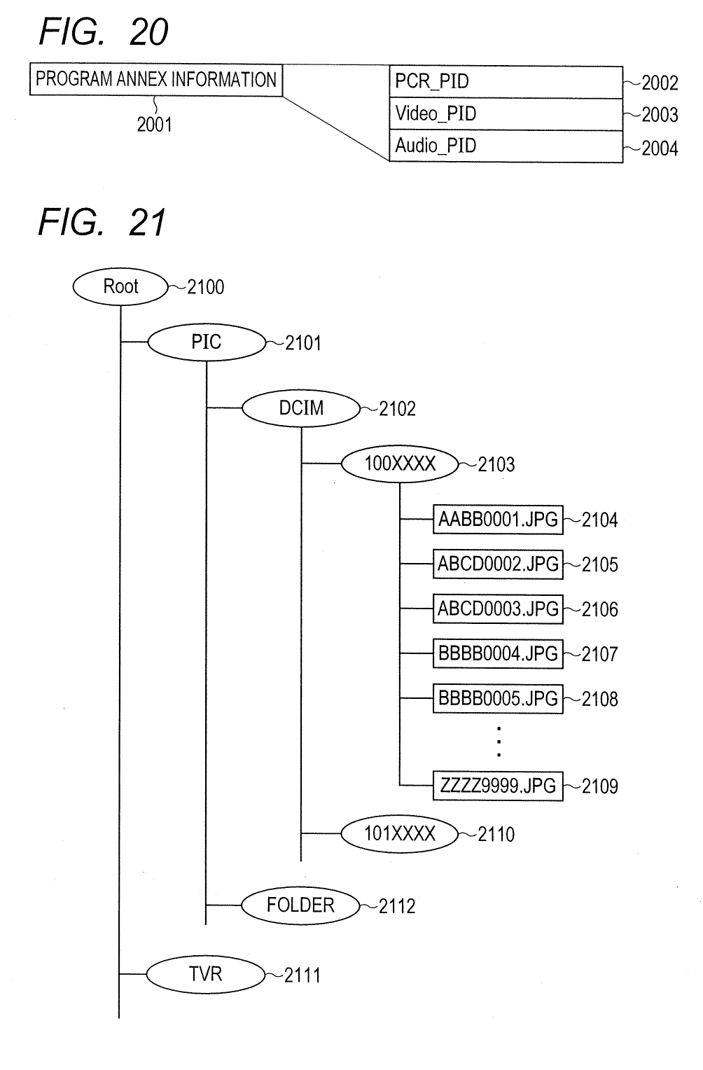

In FIG. 20, program annex information 2001 corresponds to 1134 shown in FIG. 11, and in PVR_PID 2002 (PCR: Program Clock Reference, PID: Packet Identifier, both of MPEG regulation) is recorded a PID value, i.e., a standard time within the first AV stream when recording is started.

Also in the same figure, in Video_PID 2003 is recorded the PID value of the video, when including an elementary stream (hereinafter, ES: MPEG regulation) of the video.

Also, in the same figure, in Audio_PID 2004 is recorded the PID value when including ES of audio. When reproducing, depending on the values of PVR_PID 2002, Video_PID 2003 and Audio_PID 2004 is executed the processing of distributing the TS packet (e.g., divider circuit 308 shown in FIG. 3) to various demodulator circuits (e.g., the video decoder circuit 309, the audio decoder circuit 312 and the reproduction reference counter 3020 shown in FIG. 3).

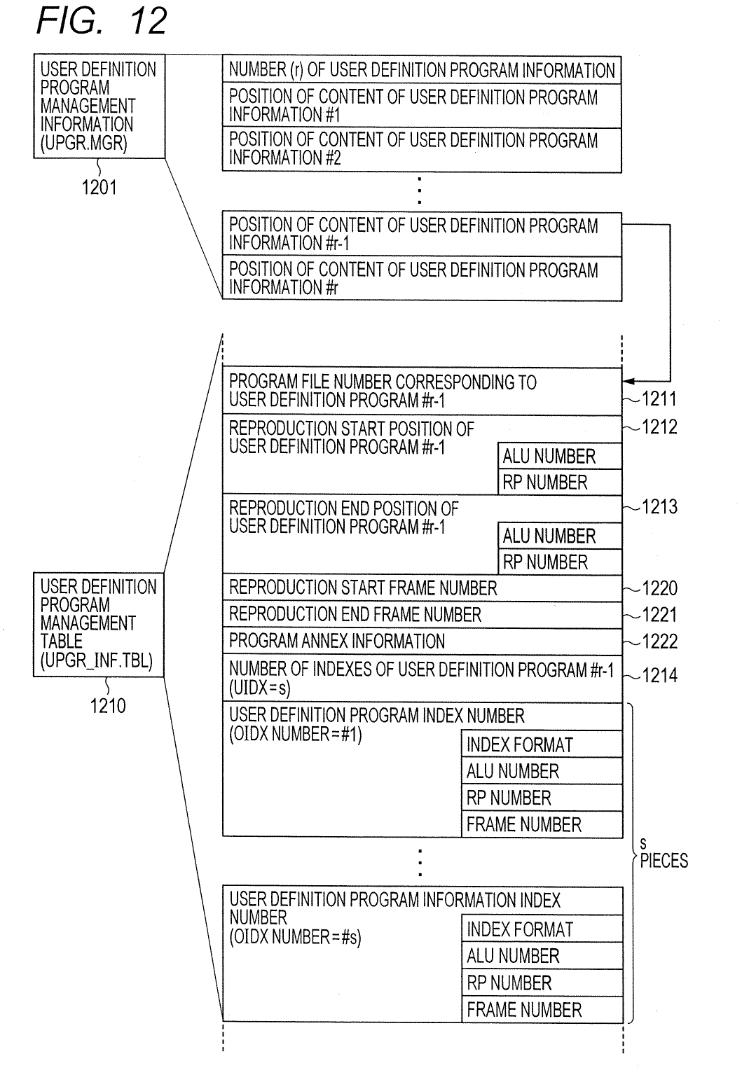

FIG. 12 shows contents of user definition program management information (UPGR) file 1201 and a user definition program management table file 1210. The user definition program management information (UPGR) file 1201 corresponds to UPGR.MGR 807 shown in FIG. 8, and the user definition program management table file 1210 to UPRG_INF.TBL 808 shown in FIG. 8, respectively. The user definition program management information (UPGR) file 1201 records therein a number of the user definition programs, which are registered by the user through editing (FIG. 12 shows the case of “r” pieces), and hereinafter, information of the position within the user definition program management table file 1210, in which contents of the user definition program information #1, the user definition program information #2 . . . the user definition program information #r−1, and the user definition program information #r are recorded (such as, the information of at which number of bytes it starts from a head of the user definition program management table file (PGR_INF.TBL) 1210, for example).

As a detailed example of the user definition program management table file 1210 shown in FIG. 12 is shown a table portion of the user definition program #r−1. As the information of the user definition program #r−1, there are disposed the followings: a file number of the program relating to the present user definition information (“xxxx” of PROGxxxx.AVS 821 shown in FIG. 8); reproduction starting position of the AV stream of the file number mentioned above (as the information, the ALU number corresponding to the top GOP, at which reproduction is designated, within the AV stream, the RP number, and the frame number 1220, at which reproduction starts, within that GOP) 1212, and reproduction ending position 1213 (as the informing, the ALU number corresponding to the GOP at a terminal of that, reproduction of which is designated, within the AV stream, the RP number and the frame number 1221, at which reproduction ends, within that GOP); and a program annex information 1222 as an annex information within the AV stream recorded. Contents of the program annex information 1222 are same to those of the program annex information 1134 shown in FIG. 11 and also to those of the program annex information 2001 shown in FIG. 20. Further, there are disposed a number 1214 of the indexes, the format for each index number, and the ALU number of the AV stream corresponding to the user definition program information #r−1, which indicates the position of the index, and the RP number of the position, which is indicated by the index, within ALU. The index is, similar to the original program information shown in FIG. 11, the designation position information when the user edits the program corresponding to the user definition program information #r−1 and designates the marking point designation, and if designating the index in the editing, it enables operations, such as, jumping the program corresponding to the original program information #−1 to the position, which is designated by the index, quickly.

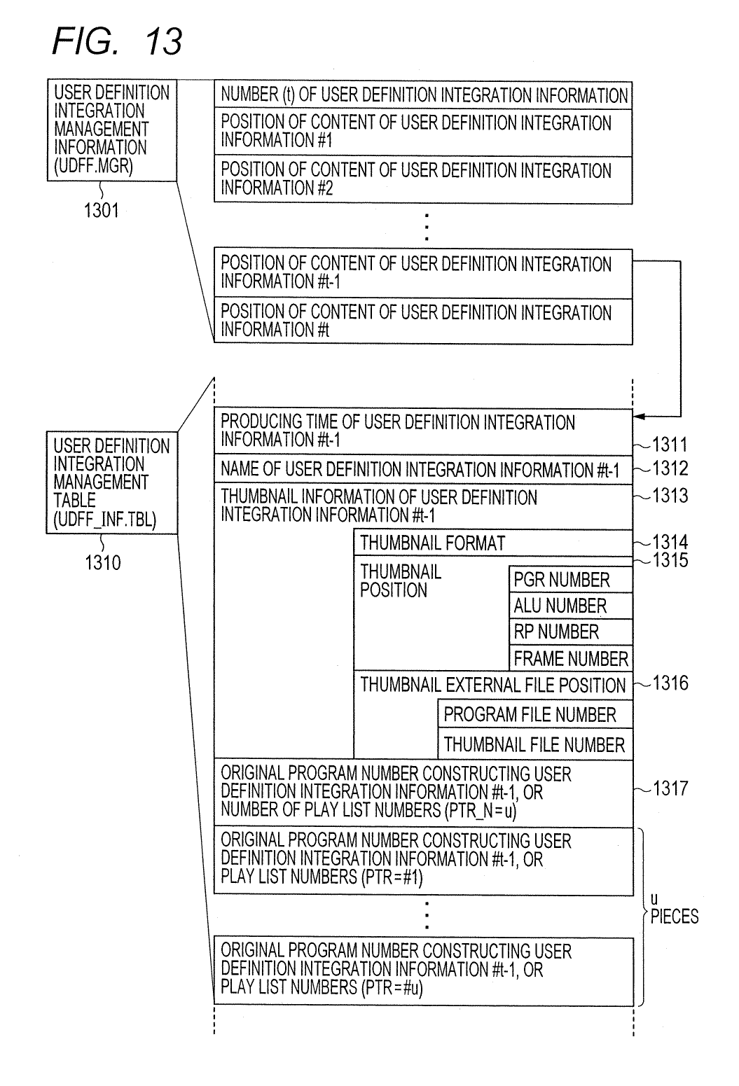

FIG. 13 shows contents of a user definition management information (UDFF) file 1301 and a user definition integration management table file 1310. The user definition management information (UDFF) file 1301 corresponds to UDFF.MGR 809, and the user definition integration management table file 1310 to UDFF_INF.TBL 810 shown in FIG. 8, respectively. In the user definition management information (UDFF) file 1301 is recorded a number of the user definition integration information, which are registered by the user through edition thereof (FIG. 13 shows the case of “t” pieces), and hereinafter, information of the position within the user definition integration information table file, in which the contents of the user definition integration information #1, the user definition integration information #2 . . . the user definition integration information #t−1 and the user definition integration information #t are recorded (such as, the information of at which number of bytes it starts from a head of the user definition integration management table file (UDFF_INF.TBL) 1310, for example).

As a detailed example of the user definition integration management table 1310 shown in FIG. 13 is shown a table portion of the user definition integration information #t−1. The present user definition integration information #t−1 is made up with, as the information thereof, production time 1311 when the present user definition integration information is produced, a name 1312 of the present user definition integration information, information 1313 of thumbnail representing the present user definition integration information, a number 1317 of the original program number building up the present user definition integration or the play list number, and an enumeration of the original program numbers following thereafter, building up the present user definition integration information, or the play list numbers.

A thumbnail format 1314, a thumbnail position 1315 and a thumbnail external file position 1316, each being the constituent element of the thumbnail information 1313, have the data structure similar to that of the thumbnail format 1014, the thumbnail position 1015 and the thumbnail external file position 1016 within the play list management table 1010 shown in FIG. 10 mentioned previously.

FIG. 16 is a view for showing correlation between the management data structure of the thumbnail and the external thumbnail file. In the same figure, the thumbnail management data 1601 is built up with a thumbnail format, a thumbnail position and a thumbnail external file, and they are same to the thumbnail information 1013 shown in FIG. 10, the thumbnail information 1115 shown in FIG. 11 and the thumbnail information 1313 shown in FIG. 13. The thumbnail position is made up with a number of the program information (PGR) of the program file 1602, an ALU number corresponding to the position of the AV stream to be displayed as the thumbnail, and a RP number within the ALU corresponding to that ALU number, and also the thumbnail external file information is made up with the program file number “xxxx” and the thumbnail file number “yy”.

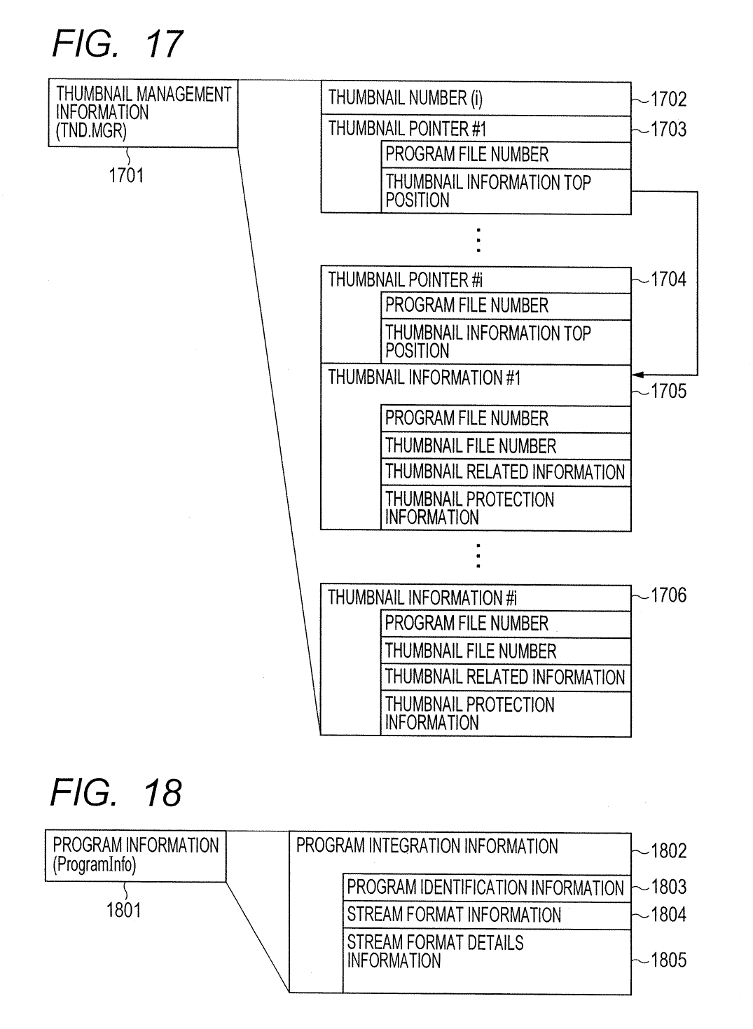

FIG. 17 shows the structure of an entire thumbnail management information file 1701, and it corresponds to TND.MGR 831 shown in FIG. 8. As the information for integrating the thumbnails, a number of thumbnails registered (present figures shows the case of “i” pieces) 1702, hereinafter, thumbnail pointers 1703-1704 having a pointer value of the position, where the information for the numbers of those registered enters into, etc., as the information thereof, and following thereto, respective thumbnail information 1705-1706. Each of the thumbnail information 1705-1706 is made up with information, such as, a program file number, a thumbnail file number, thumbnail-related information (for example, pixel sizes of length and breadth of thumbnail, compression method, etc.), and thumbnail protection information (yes/no of encoding of thumbnail). In this manner, putting the information of thumbnails together into a position, it is possible to grasp the information of the entire thumbnails, only by referring to the present entire thumbnail management information file 1701; thereby having an advantage of enabling high-speed operation, etc., when obtaining a thumbnail information list or the like, in a reproducing machine and so on, to which the present invention relates.

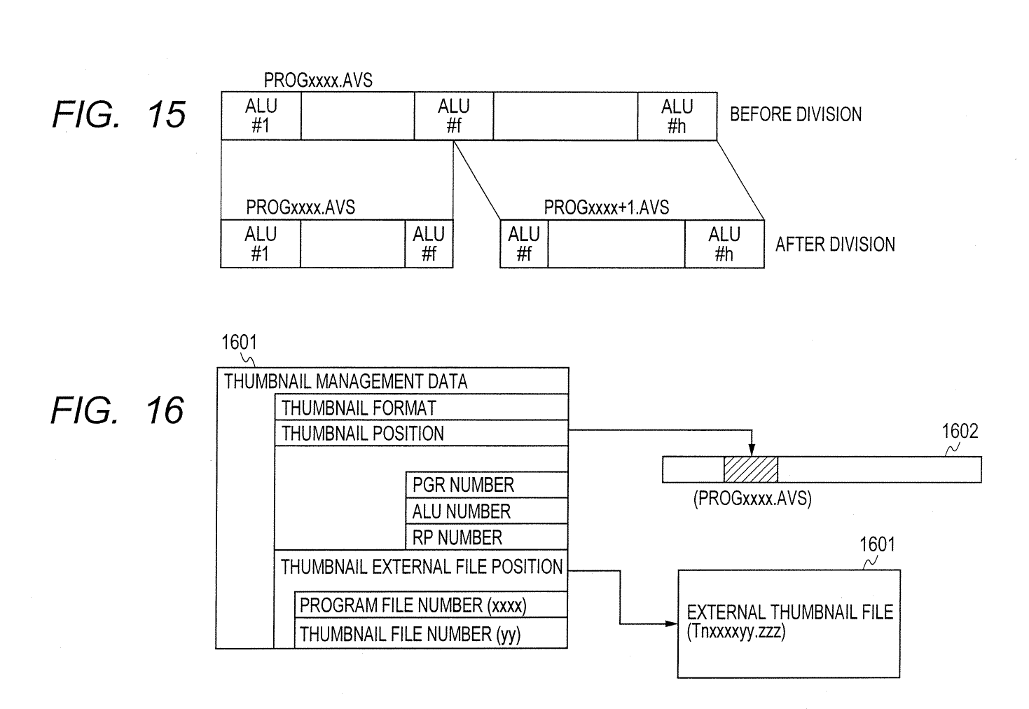

FIG. 15 is a block diagram for showing the way of how the management is executed on the program file, into which the AV stream enters, when one (1) program is divided (for example, when one (1) recorded program is divided into two (2)), in the edition operation by the user, for example. As is shown in the same figure, the AV stream of an arbitrary PROGxxxx.AVS file is disposed by a unit of ALU. For this reason, it is simple to divide it by the unit of ALU; however, if comparing the unit of ALU to the reproduction time of the recorded AV stream, it is a unit of several tens of seconds, i.e., being very rough in the accuracy of division. For this reason, at a dividing point, it is so arranged that the division can be made by a unit of RP. In this case, as shown in FIG. 15, it is divided at a portion of the ALU number #f. And, the AV streams of ALU #1-ALU#f in the divided file and the AV streams of ALU#f-ALU#h in the divided file are newly recorded, as PROGxxx.AVS and PROGxxxx+1 (“1” is added to the file number “xxxx”), respectively. In this case, since the terminal of the stream portion of PROGxxx.AVS after division does not come to a predetermined 8192 RP (shown in FIG. 14), if changing “ALU number of program” as a parameter of the ALU management information shown in FIG. 14, at the same time, “RP number of last ALU” is changed to RP number after division, i.e., the RP number in front of the point of division of ALU#f; thereby renewing the file PROGxxxx.AVS. Also, for the AV stream PROGxxxx+1.AVS after the division (FIG. 15), a parameter of the ALU management information 1403, i.e., “ALU number of program” shown in FIG. 14, is changed, and at the same time, “RP number of first ALU” is changed to the RP number after division, i.e., the RP number behind the point of division of ALU#f, and recorded. With doing in this manner, the accuracy of division point can be improved. At least, at the division point, in case of the AV stream compressed by MPEG, division can be made at accuracy of GOP (Group Of Picture) unit.

FIG. 18 shows program information 1801, and it shows the contents of the named stream ProgamInfo 824 shown in FIG. 8 mentioned previously. In the same figure, as program integration information 1802 of the original program of the recorded AV stream are the followings: program identification information indicative of being recorded in the recording format of the present embodiment; stream format information of being identification information, such as, indicative of being a digital broadcast (Japan, Europe, North America, etc.) or AV stream, which is self encoded by the recoding machine, etc., for example, as the type of the original program recorded; and stream format details information 1805, which is made up with a start-time or end-time of recording, a name or genre (category) of program, etc.

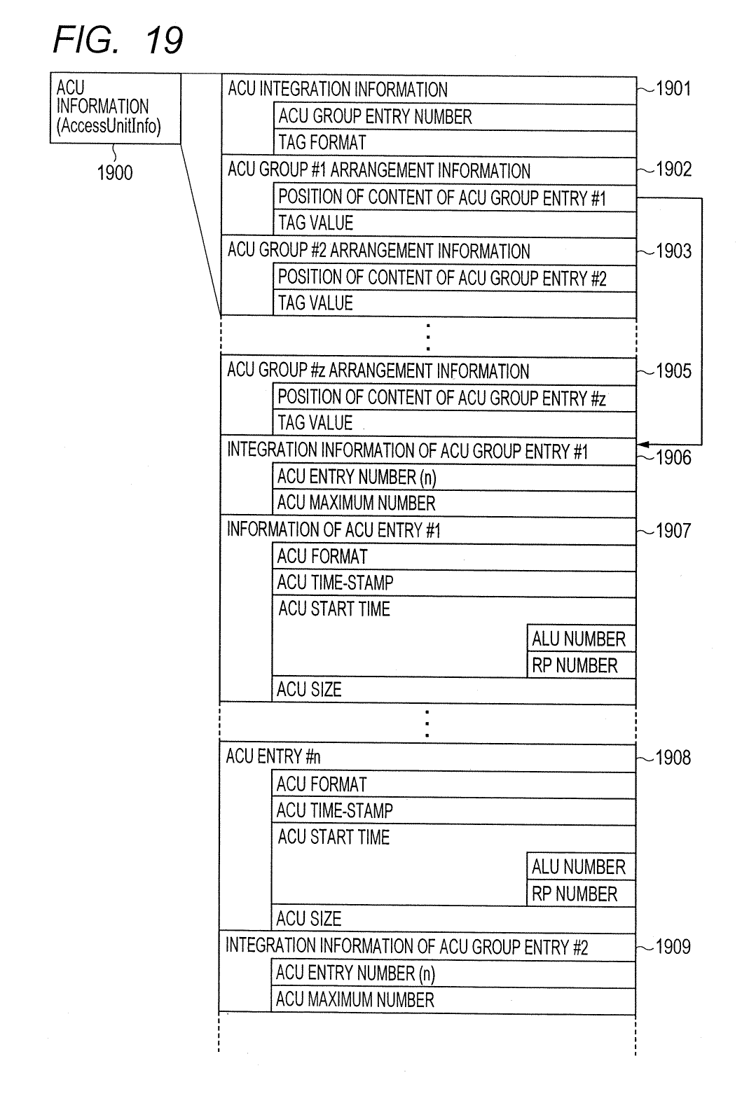

FIG. 19 shows details of ACU information 1900, and the ACU information 1900 shows the contents of the named stream AccessUnitInfo 825 shown in FIG. 8. ACU has ALU number and RP number of the portion, at which GOP of the AV stream locates (see FIG. 14), and a number of RP corresponding to length of I picture in the MPEG regulation in GO, etc., as the information thereof. In the same figure, as ACU integration information 1901, it has a number of ACU group entries as a number of ACU groups, and a tag format within the AV stream. Explanation about the value to be recorded in the tag format will be given hereinafter.

For example, in case of the digital broadcast in Europe or Japan, there is a value, being called “component tag”, necessary for reproducing the program corresponding to that ACU 1900, which indicates a type of the information building up the stream structure. If using this component tag, with an assumption of the cases where one (1) program has plural numbers of streams, within service information (hereinafter, being called “SI”), then it can be used, for example, where type of the pictures in a program is, not only one (1), but in plural numbers thereof (those of changing the photographing angle, etc.), or where there are plural numbers of audios (hereinafter, the AV stream having plural numbers of such videos or audios in one (1) program is called “multi-AV stream”), by superimposing such the information, as the component tag and displaying those to the user in the electronic program table. Then, for example, in the digital broadcast in Europe or Japan, by recording the component tag in the form of the tag, it is possible to deal with, suitably, even in the case where one (1) program has plural numbers of the streams therein.

However, in the broadcast regulation in, such as, U.S.A., etc., there are cases where no rule is made about such component tag.

Then, in case when receiving the AV stream, the component tag of which is regulated, like the digital broadcast in Europe or Japan, “00H” (“H” is an annex indicative of hexadecimal) is recorded in a tag format, while “01H” is recorded in that tag format when receiving the AV stream, the component tag of which is not regulated, for example, like the broadcast regulation of U.S.A.

With such structure of the management file, it is possible to deal with, using as a recoding management method, including the cases therein, where the component tag is determined and not, depending on the broadcasting areas, etc.

When recording such multi-stream as was mentioned above, for the purpose of enabling to manage the ACU entries of pleural numbers of groups, there is construed a table in the present embodiment; however, in a normal case, the ACU group may be only one (1) set, for each one (1) AV stream. Following to this are recorded the followings: information about the position where the content of ACU group entry #1 is disposed (for example, the content of ACU group entry #1 is recorded therein, at the position of which number of bytes, from beginning of the present ACU information 1900); ACU group #1 disposition information 1902 for recording a value therein, of the component tag corresponding to the stream of the ACU group entry #1; and following to this, ACU group #2 disposition information 1903, . . . , ACU group #z disposition information 1905. The tag value of each of the ACU group #1−z disposition information is a constituent element (or may b called “constituent information”) presenting the structure of the AV stream, and in case where there are plural numbers of streams in one (1) program, there is recorded information indicating that said ACU group #1−z correspond to which AV streams, respectively. Further following thereto are recoded: total information 1906 (composed of a total number (number of ACU entries) of ACU, which are recorded in ACU group entry #1; and a maximum value of ACU, which are recorded in the ACU group entry #1), and follow thereto, information 1907 of entry #1 of ACU, . . . , information 1908 of entry #n of ACU, total information of entry #2 of ACU, . . . . The information 1907 of entry #1 of ACU, . . . , information 1908 of entry #n of ACU are constructed with the followings, respectively, as the structure of GOP: ACU format constructed to have a flag of presence/absence of sequence header (MPEG regulation), presence/absence of GOP header or picture type building up the present ACU (for example, I-picture/P-picture of MPEG regulation. In the present embodiment, only the I-picture is assumed), etc., a timestamp of ACU, ACU number having GOP corresponding to the ACU entry number, as ACU starting position, and ACU size made up with RP number and a number of packets of the I-picture within that ALU,

With such construction of information 1900 of ACU, in this manner, it is possible to grapes the position information of the I-picture of the stream, when reproducing it, and therefore, it is possible, not only to use it in the process, such as, when conducting a search at high-speed while jumping the I-picture at a predetermined distance to be displayed when reproducing, etc., but also to grasp the information of the stream to be searched at high-speed, with using the tag value of the component tag, when reproducing.

Also, it is assumed, by means of the tag format of the ACU integration information 1901 is presented the information designated by PMT (Program Map Table: MPEG regulation), when the stream recorded does not have the regulation about the component tag (“01H” or higher than that, in the example mentioned above). Thus, it is assumed when the tag value=n, it designates n^{th} stream described by PMT. With doing in this manner, it is possible to record that, i.e., to which one of plural numbers of the stream the ACU total information corresponds, even if the component tag is not determined depending on the broadcast area or region.

FIG. 21 is a view for explaining about directory content, for recoding the management information for managing the still picture data and the still picture, according to the present invention. In the same figure, a reference numeral 2101 depicts the uppermost hierarchy of file directory, 2101 a directory named “PIC” lower than that, respectively; i.e., showing the construction of each file of the still picture data and the management information file, according to the present invention. Also, TVR 2111 is a directory for storing moving picture data and management file thereof, and it is similar to TVR 801 shown in FIG. 8, which was explained previously. In FIG. 21, a reference numeral 2101 depicts a directory named “DCIM”, in accordance with the format, which is used in a digital camera, etc., in general, and it is produced on a layer or hierarchy lower than the directory 2101. On a layer or hierarchy lower than that is produced a directory 2103 of a directory name “100XXXX”, being a format, which is used in the digital camera, etc., in general. In portion “XXXXX” of the directory, it is assumed that arbitrary 5 characters are assigned. On the hierarchy lower than directory 2103 (100XXXXX), there are stored a file 2104 named “AABB0001.JPG”, a file 2105 named “ABCD0002.JPG”, a file 2106 named “ABCD0003.JPG”, a file 2107 named “BBBB0004.JPG”, a file 2108 named “BBBB0005.JPG” and a file 2109 named “ZZZZ9999.JPG”. With those files, upper 4 digits of the file name may be an arbitrary combination of alphabets or numerals, and for example, file distinction during the reproducing process may be made by the numbers of lower 4 digits, 0001-9999. When the lower 4 digits of the file name are used up to 9999, in the directory 2103, then upper 3 digits of the directory name of the directory 2103 are newly produced to the directory of “101XXXXX”, and into that directory are newly added the files of the still picture data, in the similar manner of naming, as shown in that of the files 2104-2109. With the file structures shown in FIG. 21, they are managed by a file system of UDF, which is shown as the example, perfidiously, wherein though not shown in the figure, into each directory and each file are recorded, as attribute information, also the time when producing the file on the recording medium (year, month, day, hour, minute, second) as the management information of the file system (the file system should not limit to UDF).

A reference numeral 2112 in FIG. 21 depicts a directory named “FOLDER” of the directory name, for executing management to divide the still picture data of the direction 2101 mentioned above into folders, thereby to put them in order, and details of this will be explained, next.

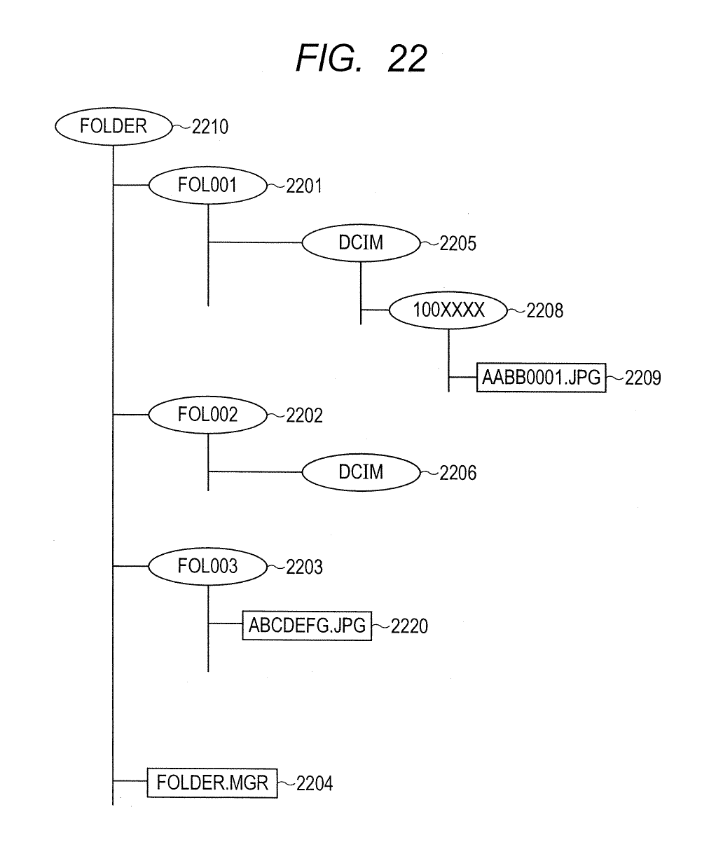

FIG. 22 is a view for explaining a distribution folder and management data thereof, which are recorded on the recording medium, for enabling the user to classify and manage the still picture data by a folder, for each, according to the present invention. In FIG. 22, 2210 depicts a directory named “FOLDER”, for storing the still picture data and the management information file therein, thereby for dividing or distributing the still picture data into folder, and it is same to that of 2112 shown in FIG. 21. In FIG. 21, 2201, 2202 and 2203 depict directories named “FOL0001”, “FOL0002” and “FOL0002”, respectively, for dividing or distributing the still picture data, and on a layer or hierarchy lower that those are produced directories 2205 and 2206 named “DCIM”. Further, numerals of lower 4 digits of the directory name of the directory 2201, 2202 or 2203 are folder number. 2208 is a directory named in accordance with a naming rule (i.e., 3 digits of numerals and arbitrary 5 alphabetic characters) same to that of the directory 2103 (“100XXXXX”) mentioned in the explanation of FIGS. 21, and 2209 is a file of the still picture data divided or distributed into the folder 2201 (“FOL0001”). For example, when distributing the file 2104 (“AABB0001.JPG” in FIG. 21) into the directory 2201 (“FOL0001”) shown in FIG. 22, as is shown in FIG. 22, recoding is made while building up such structure, i.e., a directory 2205 (“DCIM”), a directory 2208 (“100XXXX”) and a file 2209 (“AABB0001.JPG”). In this instance, for example, the name of the file 2209 may be same to that of an origin of distribution, or may be changed from the name of the origin of distribution, as far as it follows the naming rule of the file name (4 characters of an arbitrary combination of alphabets and/or numerals and a 4 digits number). Also, as an example, 2220 in FIG. 22 depicts a file named “ABCDEFG.JPG” of the still picture data, which is not in conformity with the naming rule (4 characters of an arbitrary combination of alphabets and/or numerals and a 4 digits number), in this manner, when making managing the still picture data file shown in FIG. 21 to be distributed to a folder, without providing the “DCIM” folder below the distribution folder, as shown by the distribution folder (“FOL0003”) shown in FIG. 22, the file 2220 (“ABCDEFGH.JPG”) of the still picture data is located just under the folder 2203. With doing in this manner, it is possible to determine on whether it is the file of the still picture data or not, in conformity with the naming rule, which is defined in FIG. 21, and in addition thereto, upon basis of a result of that determination, it is possible to exchange the control when reproducing, easily. Also, if the file structure of the origin of folder distribution is the structure of the hierarchy, lower than the directory 2101 shown in FIG. 21, for example, there can be obtained an advantage that almost of parts of controlling logic when reproducing can be used in common, by brining the file structure of the file on the hierarchy lower than the directory 2205 and 2206 into the structure same to the file structure of the origin of the folder distribution, and further, when reading the file structure of the recoding medium by means of a personal computer, it is also possible to determine of whether the still picture data is that distributed from a common digital camera, or not, by seeing the structure of the content of the distributed folder itself. Further, in FIG. 22, 2204 depicts a management file named “FOLDER.MGR” for managing each of the directories 2201 (“FOL0001”), 2202 (“FOL0002”) and 2203 (“FOL0003”) lower than the directory 2210 (“FOLDER”), and the details thereof will be explained below.

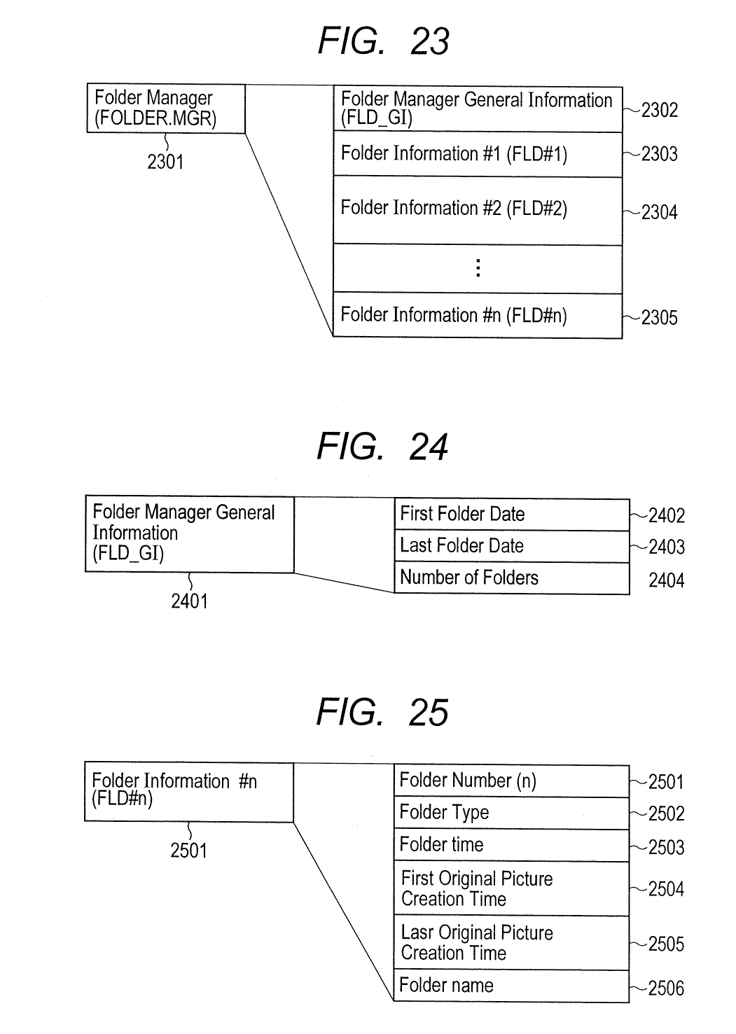

FIG. 23 is a view for showing the details of contents of the management file of the directory 2204 (“FOLDER”) shown in FIG. 22. In FIG. 23, 2301 depicts the uppermost hierarchy (Folder Manger) of the management file (i.e., “FOLDER.MGR in FIG. 22). 2302-2305 depict management information of the hierarchy lower than that, and contents of the management information thereof will be explained, hereinafter. In 2302 is recorded the information (Folder Manager General Information) when the present management file 2401 is produced or renewed on the recording medium. Details of that will be mentioned later. Into 2303-2305 are recorded the management information (i.e., Folder Information #1, Folder Information #2, . . . , Folder Information #n) corresponding to distribution destination folders produced, one by one, respectively. Further, in the present embodiment, it is assumed that each folder management information is coordinated with the folder number of the distribution destination, such as, the management information 2302 (Folder Information #1) is recorded by coordinating with the management information of the distribution folder 2201 (“FOL0001”) shown in FIG. 22, and the management information 2304 (Folder Information #2) is recorded by coordinating with the management information of the distribution folder 2202 (“FOL0002”), and so on, for example.

FIG. 24 shows details of the management information 2302 (Folder Manager General Information) shown in FIG. 23. In 2402 is recorded the management information (First Folder Date) of the information when the distribution destination folder is recorded, at first, on the recording medium (date, hour, minute, second, etc.). In 2403 is recorded information (Last Folder Date) of the management information (date, hour, minute, second, etc.) when the distribution destination folder is recorded, at last, on the recording medium. In 2404 is recorded a number (Number of Folders) of the distribution destination folders produced.

FIG. 25 is a view for showing the content of the management information 2305 (Folder Information) of the folder number #n. In FIG. 25, 2501 depicts that same to the management information 2305 of the folder number #n shown in FIG. 24. 2501 depicts the management information of memorizing the folder number of distribution destination therein, and when indicating the directory 2201 (“FOL0001”) indicative of the distribution destination folder shown in FIG. 22, for example, in the management information 2501 herein is recorded the folder number #n=1. 2502 depicts the management information (Folder Type) for discriminating on whether the file of the still picture data distributed into the distribution destination folder is of the format of the common digital camera mentioned above, or not. In case where the folders are divided by a folder of the format of the directory 2205 (DCIM) or 2206 (DCIM) of the file format of the common digital camera, like the directory 2201 (“FOL0001”) or the directory 2202 (“FOL0002”) shown in FIG. 22, previously, for example, “1” is recorded in the management information 2502. In case where there is stored data, not of the file format of the common digital camera, like the directory 2203 (“FOL0003”) shown in FIG. 22, previously, etc., for example, “0” is recorded in the management information 2502 shown in FIG. 25. Accordingly, with the present embodiment, since a fact is recorded in the management information 2502 of whether the folders are divided by the format of the common digital camera, or not, it is easy to determine a process of control when reproducing (for example, the control of displaying child picture information of the still picture data on the screen (e.g., a thumbnail display), reproducing them upon an instruction of the user, one by one, or reproducing them on a slideshow mode), of if it can be executed upon basis of the file management of the common digital camera format or not, or it needs other control(s) or not, therefore logics of the control program for executing the reproduction process becomes simple, and then high-speed of the processing speed can be expected therein.

In 2503 is recorded date, hour, minute and second thereof, if the directory of #n is produced.

In 2504 is recorded the values of the date, hour, minute and second of the earliest period of the still picture data distributed into the folder of #n, as the management information. In 2505 is recorded the values of the latest period of the still picture data distributed into the folder of #n, as the management information. Those management information 2504 and 2505 are determined and recorded, by referring to the attribute information of the file system of the file of the still picture data distribute into the folder. Accordingly, if watching the management information 2504 and the management information 2505, it is possible to execute the display process, without executing the process of confirming the file attribute of the still pictured data in the folder of #n when reproducing, for example, at the time when displaying it on the screen, in which period the still picture data distributed into the folder of #n are photographed; therefore, it is possible to shorten the time and so on, up to displaying a photographing period. An example of this screen display will be mentioned later.

In 2506 is recorded an arbitrary name, which the user designates to the folder of #n.

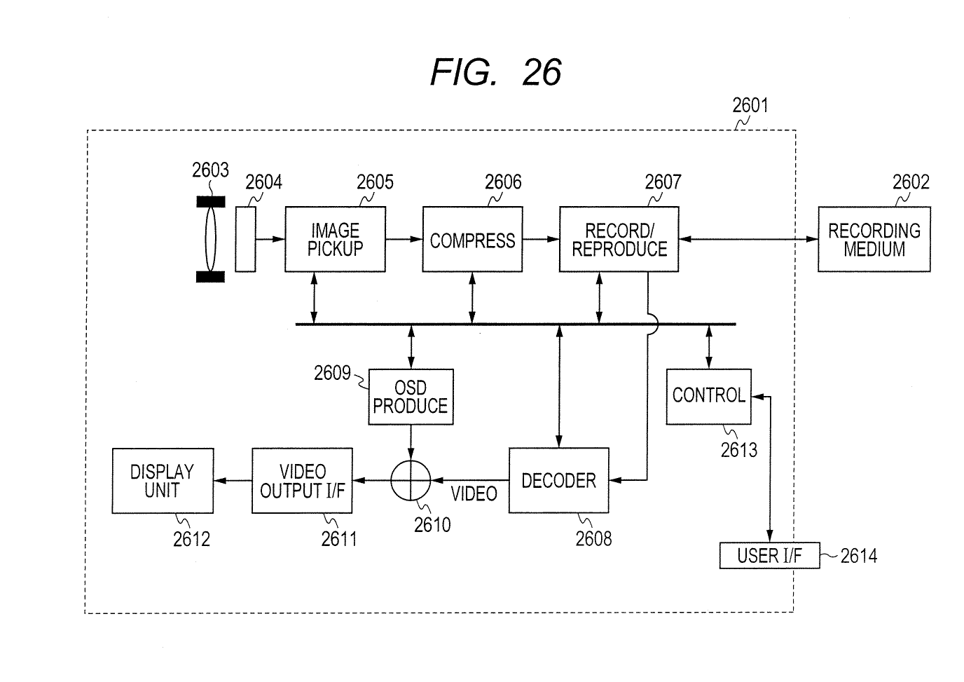

FIG. 26 is a system block diagram of a camera applying the recording method according to the present invention therein. In FIG. 26, 2601 depicts a main body of the camera. 2602 depicts a recording medium, and it may be that of built-in type or that of detachable type. 2603 depicts a lens, 2604 an image sensor, 2605 a photographing processor circuit for executing a conversion process from a pickup signal to an image or video signal, 2606 a compressor circuit for compressing the video signal, 2607 a recording/reproducing unit for writing compressed data onto the recording medium or reading out it from the recording medium, 2608 a decoder circuit for extending the compressed data into the video signal, 2609 an OSD (On Screen Display) circuit for producing signals of graphical user interface, 2610 an adder circuit for adding the OSD signal onto the video signal at a predetermined adding ratio, 2611 a video signal output unit, respectively, and 2612 depicts a display unit, which may be a liquid crystal panel built within the camera 2601, or other display separated from the main body of the camera 2601, for example a TV, etc. 2614 depicts a user I/F unit, which is constructed with a button, a touch panel or a remote controller, etc. 2613 depicts a controller unit for controlling each of the constituent elements within the camera 2601, in accordance with an input via the user I/F unit 2614.

When executing the recording process, the signal photographed or picked u by the image sensor 2604 through the lens 2603 is converted into the video signal, being compressed within 2606, and it is recorded onto the recoding medium through the recording/reproducing unit 2607.

Also, when executing the reproducing process, the compressed data recorded on 2602 is read out through the recording/reproducing unit 2607, extended into the video signal within the decoder circuit 2608, and added with a screen image of the graphical user interface (GUI) produced in the ODS circuit 2609, at the predetermined adding ratio; and thereafter, it is displayed on the display unit 2612 through the video output I/F 2611. Also, when executing the edition for dividing the files of still picture data, which was mentioned previously, GUI necessary for folder production/editing is produced/controlled by the controller unit 2613, in accordance with the input into the user I/F unit 2614, and is added with a predetermined child picture of video data (i.e., a thumbnail) or the like, at the predetermined adding ratio, within the adder circuit 2610, and then it is displayed on the display unit through the video output I/F 2611, as an editor screen. The predetermined child picture (e.g., the thumbnail) of the video data mentioned above can be obtained through the recoding medium 2602, the recording/reproducing unit 2607 and the decoder circuit 2608.

FIG. 29 is a system block diagram of a reproducing apparatus for executing the reproducing method therein, upon basis of the recording method according to the present invention. In FIG. 29, 2901 depicts a reproducing apparatus. 2902 depicts a recording medium. 2907 depicts a reproducer unit for reading out the compressed data from the recording medium, 2908 an extension circuit for extending the compressed data into the video signal, 2909 an OSC (On Screen Display) producer circuit for producing the signals for the graphical user interface, 2910 an adder circuit for adding the OSD signal to the video signal at a predetermined adding ratio, 2911 a video signal output unit, respectively, and 2912 depicts a display unit, which may be a liquid crystal panel built within the camera 2601, or other display separated from the main body of the camera 2601, for example a TV, etc. 2914 depicts a user I/F unit, which is constructed with a button, a touch panel or a remote controller, etc. 2913 depicts a controller unit for controlling each of the constituent elements within the camera 2601, in accordance with an input via the user I/F unit 2914.

When executing the reproducing process, the compressed data recorded on 2902 is read out through the reproducer unit 2907, extended into the video signal within the extension circuit 2908, and added with the a screen image of the graphical user interface (GUI) produced in the ODS circuit 2909, at the predetermined adding ratio; and thereafter, it is displayed on the display unit 2912 through the video output I/F 2911. Also, when executing the edition for dividing the files of still picture data, which was mentioned previously, GUI necessary for folder production/editing is produced/controlled by the controller unit 2913, in accordance with the input into the user I/F unit 2914, and is added with a predetermined child picture of video data (i.e., a thumbnail) or the like, at the predetermined adding ratio, within the adder circuit 2910, and then it is displayed on the display unit through the video output I/F 2911, as an editor screen. The predetermined child picture (e.g., the thumbnail) of the video data mentioned above can be obtained through the recoding medium 2902, the recording/reproducing unit 2907 and the extension circuit 2908.

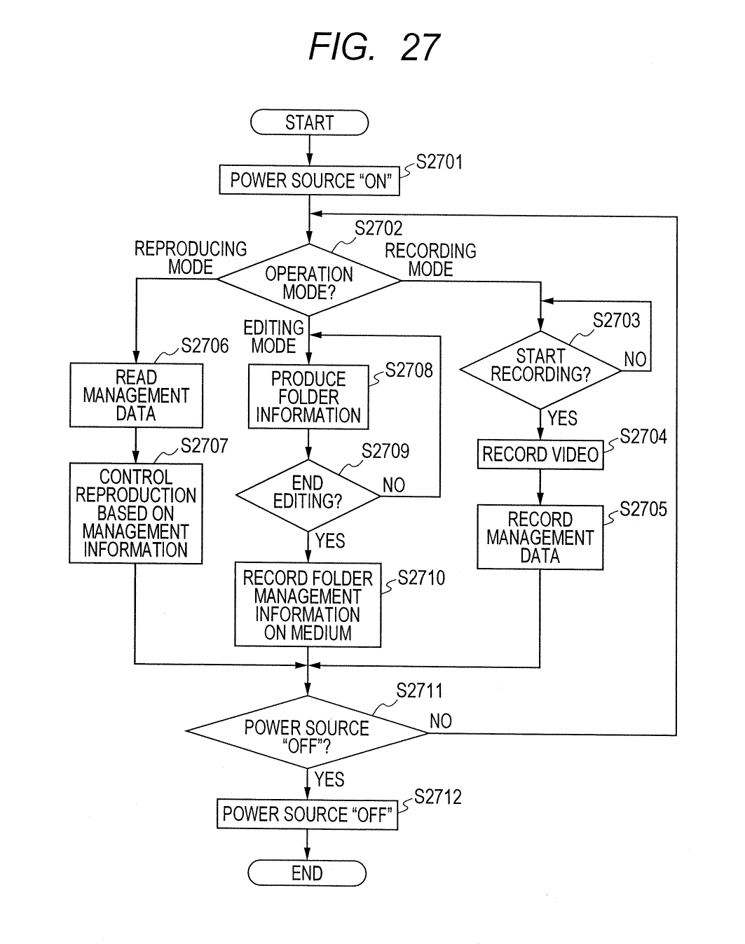

FIG. 27 shows a flowchart for explaining the recording process when recording is made by the camera 2601 mentioned in FIG. 26, or the process when reproducing, in the camera 2601 mentioned in FIG. 26, or in the recording/reproducing apparatus 300 mentioned in FIG. 3, or in the reproducing apparatus 2901 mentioned in FIG. 29, or a series of processes for distributing a file of the still picture data into the distribution destination folder. In FIG. 27, after executing an initialization process S2701 when a power source of a set is turned on, a blanching process is executed in an operation mode determining process S2702, for blanching into a reproduction mode, an edition mode or a recording mode, depending on the condition of the user I/F 2614 (see FIG. 26). In case of the recoding mode, for example, if a record button is pushed down within the user I/F 2614 (see FIG. 26), within a recording start determining process S2703, then in a video recording process S2704 is executed a recording process for recording the video data (may be the moving picture or the still picture), and thereafter, in a management data recording process S2705, recoding of other management data (including the file system management information) for managing the video data is made on the recording medium. In the edition mode, depending on the input to the user I/F 2613 (see FIG. 26) or to the user I/F 316 (see FIG. 3), producing of information of each distribution destination folder and/or the directory thereof, and moving or copying of the still picture data into the folder are executed in a distribution destination folder information producing process S2708. If determining an end of the edition, depending on the input to the user I/F 2613 (see FIG. 26) or to the user I/F 316 (see FIG. 3), in a edition end determining process S2709, then the folder management information is recorded, in a management information recording process S2710, and further, predetermined information, such as, the file system management information, etc., are recorded on the recoding medium. In the reproduction mode, within a management data reading process S2705, a reading process is executed of each distribution destination folder and/or the management data thereof, and then, depending on the input to the user I/F 2613 (see FIG. 26) or to the user I/F 316 (see FIG. 3), a reading process of each distribution destination process and a reproduction process of the still picture data within the distribution destination folder upon basis of the management information. After execution of the series of the processes mentioned above, if it is determined that the power source is not turned off in a power source determining process S2711, depending on the input to the user I/F 2613 (see FIG. 26) or to the user I/F 316 (see FIG. 3), the process is shifted to the operation mode determining process S2702, again, and if determined that the power source is turned off, then the process is ended after executing a predetermined ending process.

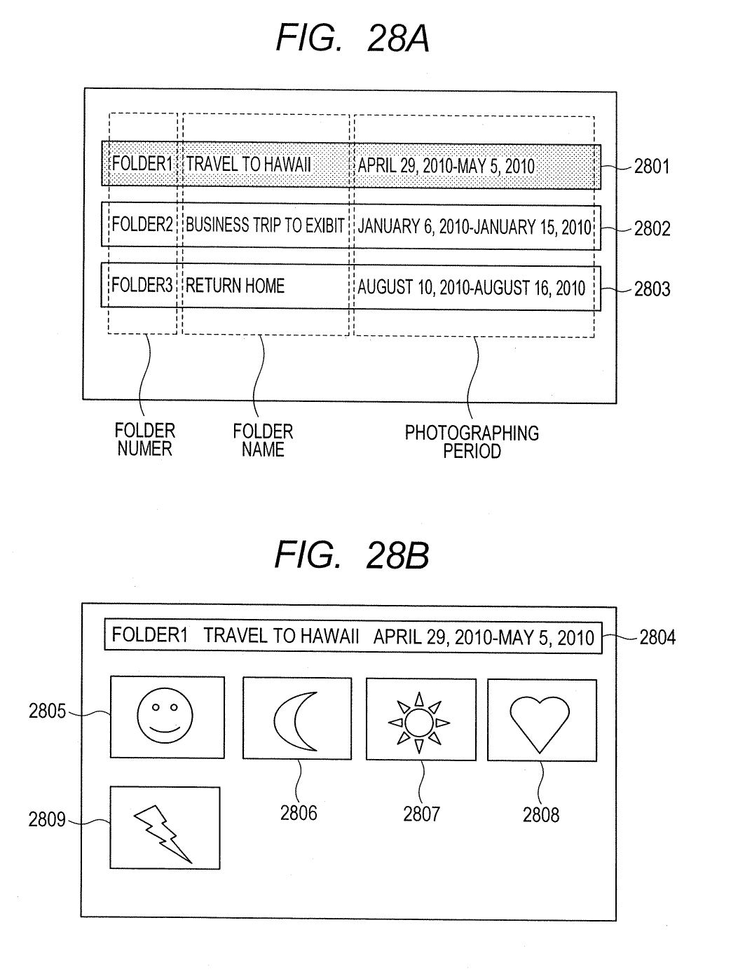

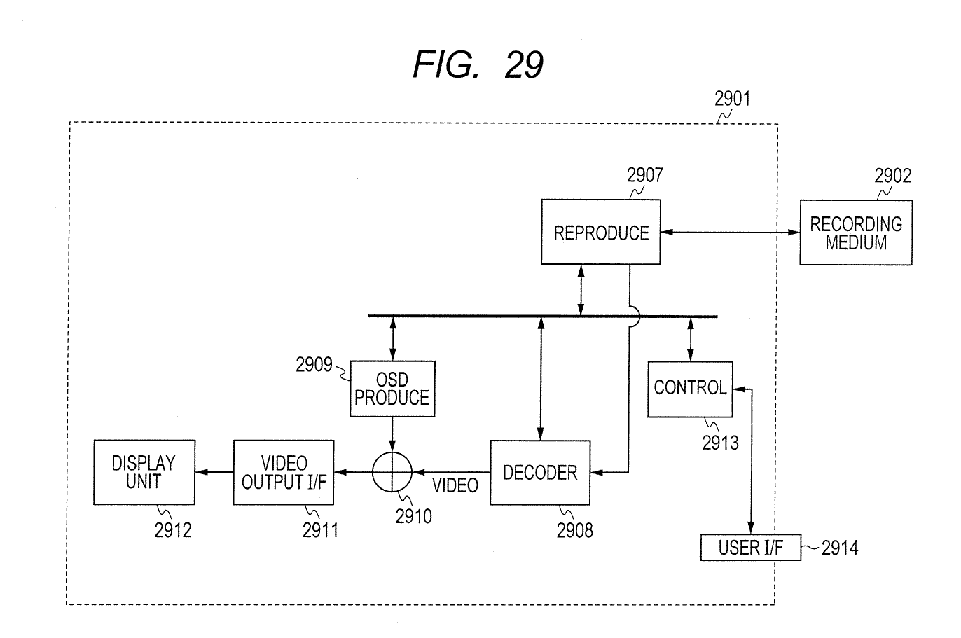

FIGS. 28A and 28B show an example of display of the graphical user interface when reproduction is made on the recording/reproducing apparatus shown in FIG. 3, the camera shown in FIG. 26, or the reproducing apparatus shown in FIG. 29, etc., upon basis of the recording method explained in the above heretofore. FIG. 28A shows an example of the display of a list of distribution destinations, wherein 2801, 2802 and 2903 presents the distribution destination folders, respectively. 2801 shown by solid-white characters indicates that it is a folder selected at present. Also, the folder presentations 2801, 2802 and 2803 are presented with a folder number, a folder name and photographing period, respectively. The information for presenting those information can be obtained from the management information 2501 (Folder Number (n)), the management information 2506 (Folder Name), the management information 2504 (First Original Picture Creation Time) and the management information 2505 (Last Original Picture Creation Time), and therefore, it is possible to omit such process, i.e., reading all of the attributes of the files of the still picture data in the folder, when controlling the display, and picking up the earliest one and the latest one of photographing date/hour to be displayed; there can be expected high-speeding of the displaying process for it. Also, the user who uses it can grasp, not only the folder name indicating the information content of the folder, but also the period of photographing those; therefore it is convention for her/him.

FIG. 28B shows an example of the display of Folder 1, after selecting a folder presentation 2801 shown in FIG. 28A. 2804 displays a folder number, a folder name and a photographing period. 2805-2809 are displays of thumbnails of the still picture data in the selected folder. Also, on this display screen, the user who uses it can grasp, not only the folder name indicating the information content of the folder, but also the period of photographing those; therefore it is convention for her/him.

Also, if managing the AV stream (moving picture) recording method lower than the directory 801 (see FIG. 8) and the still picture recording method lower than the directory 835 (see FIG. 8), which are explained in the above, on the same medium, it is possible to manage the moving picture and the still picture on the same medium, and further, to manage the recording/reproducing, most suitably or appropriately, on the moving picture and the still picture, each.

However, the present invention should not be restricted to the embodiments mentioned above, but various embodiments may be included therein. For example, the embodiments mentioned above are mentioned in details thereof, for the purpose of easy understanding of the present invention; but the present invention should not be limited, necessarily, only to that including all of the constituent elements, which are explained in the above. Also, it is possible to replace a part(s) of the constituent elements of a certain embodiment by a constituent element(s) of other embodiment, or to add a constituent element(s) of other embodiment to the constituent elements of a certain embodiment. Also, with a part of the constituent elements of each embodiment, it can be added, deleted and/or replaced by that of other embodiment(s).

Also, each of the constituent elements mentioned above, a part or all thereof may be constructed with hardware, or may be constructed to be achieved with execution of program by a processor. Also, there are shown control lines and/or information lines, which are considered to be necessary for the explanation, and it is not always true that all of the control lines and the information lines are shown, which are necessary for an actual product. In actual, it can be considered that almost of all constituent elemens are connected with, mutually.

What is claimed is:

1. A recording method, for recording
still picture data, and
management information for managing said still picture data, wherein
said management data includes
information for classifying said still picture data into each classifying unit, and
a file format of said still picture data classified into the each classifying unit.

2. A recording method, for recording still picture data and management information of said still picture data, comprising the following steps of:
a step for recording said still picture data; and
a step for recording said management information, wherein
said management information includes,
classification information for classifying said still picture data into a predetermined unit, and
information indicative of a file format of the still picture data classified into said predetermined unit.
